(19) United States
(12) Patent Application Publication
(10) Pub. No.: US 2021/0056866 A1
(43) Pub. Date: Feb. 25, 2021

(54) Portable Reading, Multi-sensory Scan and Vehicle-generated Motion Input

(71) Applicants: Seungoh Ryu, Newton, MA (US); Benjamin Ryu, Newton, MA (US)

(72) Inventors: Seungoh Ryu, Newton, MA (US); Benjamin Ryu, Newton, MA (US)

(21) Appl. No.: 17/000,246

(22) Filed: Aug. 21, 2020

Related U.S. Application Data
(60) Provisional application No. 62/890,015, filed on Aug. 21, 2019.

(51) Int. Cl. G09B 21/00

(52) U.S. Cl. CPC G09B 21/007; G09B 21/003

(57) ABSTRACT

A device compensating limits of humans senses, includes a receiver receiving information in a first sense, a converter converting the received information into information in a second sense and a presenter that presents the converted information. In an embodiment, the first sense is the vision and the receiver receives visual information comprising texts, wherein the second sense is auditory sense or tactile sensation, and the receiver comprises an ingestion layer that ingests information from a target object. In another embodiment, the receiver ingests the full audio or visual sensory stimuli, and takes the portion that is blocked for the sensory deprivation of the user, and the converter extracts environmental cues contained therein by applying machine intelligence logic and makes trans-sensory conversion to their synthetic representation.

### CROSS-REFERENCE TO RELATED APPLICATION

This application claims priority on the inventors' provisional application no. 62/890,015 filed on Aug. 21, 2019, the disclosure of which is incorporated by reference.

### BACKGROUND OF THE INVENTION

The present invention relates to a Portable Reading Device for Visually impaired and Other Sensory Limited User Assistance.

Braille is the prime example where the tactile sensor substitutes for the vision in ingesting the presented content. The traditional Braille is composed of embossed symbols (each composed of up to six or eight dots) that represent the alphabet characters. The method is as reliable and accurate as reading a printed page: it does not require any ephemeral component such as the electrical display or audio output and is free of any interpretational ambiguity for a trained user. In some countries, the law requires medical labels and building/street signs be available in Braille. Banknotes and some commercial product labels are also represented in Braille in Canada and the UK.

However, mastery of Braille requires a significant amount of training. As the computerized screen reader gains more popularity, and due to the relative paucity of Braille books as well as educational policy shifts to integration, Braille-literacy has been dwindling. Less than 10% of the legally blind are estimated to be Braille-literate. According to the American Printing House for the Blind, there were 61,739 legally blind students registered in the U.S in 2015. Of these, only 8.6% (5,333) were registered as Braille readers, 31% (19,109) as visual readers, 9.4% (5,795) as auditory readers, 17% (10,470) as pre-readers, and 34% (21,032) as non-readers.

Despite recent various efforts to reverse the trend (for example, the recent NYTimes article on Lego—New York Times “Lego Is Making Braille Bricks. They May Give Blind Literacy a Needed Lift.”, 2019 Apr. 27), it is an uphill prospect given the intrinsic limitation, that is of the steep learning curve and dwindling reward, of the method.

Is Braille on its way to be phased out entirely? Despite the steep learning curve, Braille is still recognized as the most effective and non-intrusive method to ingest volumes of prepared text. Those who are trained in ambidextrous Braille reading achieve consistent and speedy throughput. [e.g. search http://www.youtube.com for “Braille Tracking Techniques” ] This is one of the motivations for incorporating the variant of Braille inspired method as part of the invention presented herein.

Efforts to “update” Braille for the digital era met a mixed level of success. An example of the improvement is a commercial product named ‘Dot’. [http://www.dotincorp.com] The device of a watch-like form ‘displays’ the time programmatically rendered in Braille using a set of mechanically manipulated plastic pins. Another example is an eBook device (as reported in the New York Times, 2018/09/03 “Braille for a New Digital Age”) that renders Braille on the device screen using a dynamically refreshable liquid matrix based on active block copolymers. [http://www.blitab.com and http://www.techtimes.com, “Smart Liquid May Pave Way For Tactile Tablet Touch Screens For The Blind” ]

These examples introduce programmability that allows Braille pattern to mutate its pattern in response to the change in the textual content at a given moment. They represent an improvement over the static Braille rendition based on embossed dots on the paper medium. They allocate the fixed space to display the Braille pattern over which the user is required to move his finger across to ‘read’, which the current invention considers as a serious deficit.

What would it take for the blind to elevate the reading experience such as picking out a stack of books from the shelf for research, browsing one for a while, switching back and forth among multiple pages or volumes? How to bring convenience features of a modern electronic reading device such as highlighting, annotating, navigating options, and utilizing functions such as looking up a dictionary or changing the mode of operation as part of the reading task? Given the ubiquity of powerful and mobile computing devices (mobile phones, tablets), how to make efficient use of their computing power instead of being forced into an all-in-one special-purpose device that is expensive and slow to keep up with the rapid progress in newly enabled technologies?

As the downstream presentation device, existing Braille-style or the auditory methods are limited in meeting those requirements as follows.

Source Scarcity Issue: Only about 1% of existing books are estimated to be available now in the Braille format. The representation for the ephemeral text that is generated and needs to be consumed immediately, is dismal. As most of the textual data are produced in the digital form already, the upstream source scarcity problem is alleviated, except for the legacy content (i.e. pre-digitized books). But the information flow is still constricted downward unless the final delivery of the said information is timely, accessible, and dynamic, in ways analogous to the difference between the static printed page and the refreshable display devices.

Serialism Issue: The text-to-verbal conversion is a viable way to assist the visually impaired people in their reading activities. For dedicated reading activities, the “audiobook” format has gained popularity both for the general public and the visually-impaired.

Its adaptation for the visually impaired demographic would typically occur through the following stages: an optical scanner or a camera ingests the source text, a computer vision logics prepares the source image fit for extraction of text symbols through an OCR (optical character recognition) logic, and a set of logical units that synthesize and deliver the audio stream and let the user control.

This kind of “screen reader” is limiting due to the serial nature of the speech transmission. A neurological side-effect is that the train of “speech” demands exclusive attention on the user's part, a problem for the visually impaired once outside of a dedicated “reading” activity. Listening to a book and background music simultaneously is hardly as enjoyable an experience as for those who have both vision and auditory senses intact.

There is also the navigational barrier: The cursory shifting of focus from one paragraph to another is a trivial and common maneuver in the normal reading activity. Using visual cues such as the line breaks between paragraphs, the reader of a book easily knows in advance how long the current sentence is before. Flipping pages and jumping around while looking for a particular word or a pattern is also a pleasurable and useful part of browsing activity. The human speech streams, even if read at ×3 speed, are not conducive to such non-linear navigation. The ideal ‘reading device’ is yet to fully realize the potential that allows faster and parallel transmission of textual content to the visually-impaired user, and the said user's feedback to the device in a manner comparable to the normal reading pattern.

Selectivity and Feedback Issue: When the user's textual environment evolves dynamically, either due to the user's physical navigation and/or shifting of focus, or due to the nature of the source, the ingestion-, conversion-, and presentation layers of the textual information flow should keep up with and adapt to the change concurrently.

Consider browsing a book. The vision-enabled user can easily shift around various text objects thanks to cognitive awareness of the page as a two-dimensional space, intricate coordination of his muscles (that control eyeball orientation and lens thickness), and the feedback based on intuitive recognition of text structures—sentences, blocks, delimiters, etc embedded in the page as hierarchical constructs. Even when the eye is focused on a character or word, the peripheral vision allows the constant evaluation of where he ‘is’ on the page that enables the efficient and precise shifts when the need arises.

Replicating this level of awareness of the multi-level organization of the textual environment for the visually impaired reader needs more than following passively along the one-dimensional string of characters and words through the traditional Braille or audio recording, even if with the controllable speed.

The present invention also relates to a Multi-sensory Environmental Scanner.

Worldwide, a significant number of people are afflicted with sensory deprivation. According to the World Health Organization (WHO), 1.3 billion people live with some form of distance or near vision impairment in 2018. Of these, 188.5 million have mild-, 217 million have moderate to severe vision impairment. Of these, 36 million people are blind. As of 2020, over 5% of the world's population has disabling hearing. It is estimated that by 2050, one in every ten people will have disabling hearing loss.

Historically, various aiding props and devices have been devised and used universally. For example, the walking cane helps the visually impaired person navigate and avoid pitfalls on the street; the hearing trumpet famously helped the composer Beethoven have conversation with his visitors. In modern times, the digital hearing aid has made dramatic improvement in both sound quality and size.

On the pedestrian crossing, the traffic light makes voice announcements such as “wait” and “walk” that substitute for the green and red lights. On computers and mobile communication devices, sensory substitution has become a common practice. Most of the functionalities mediated through the visual user interface (GUI) for normal users are now accessible to the sensor deprived via such sensory substitutes generally accessible under the category of “Accessibility” features. In most of these, the device's functionality invoked by the user action has no bearing on the sensory channel being used to mediate. Consider a button displayed on the device screen. The button displays the small image that symbolizes the nature of the action (e.g. “Play”) that pressing it invokes. A rudimentary ‘Accessibility’ feature will verbally pronounce “Play” when the finger hovers over the button to explain what it does. Often cumbersome, the probability of this sensory substitution—the aural for the visual—failing to fulfill its function is extremely small due to the narrow scope of the situational context, i.e. a simple transaction of precise information and the user already knows what to expect.

In both cases, it is an ‘atomic’ transaction: the symbolic content (‘walk’/‘wait’ in traffic lights; ‘play’/‘pause’ in music player on phone) is transacted between the environmental context and the user. Whether it is mediated by the visual or by the aural channel, the interpretation of what is passed leaves no ambiguity.

Any sensory deprivation is bound to compromise the afflicted person's wellbeing on many levels. Naturally, there have appeared inventions aiming to fill the cognitive gap using the computer and sensor technology, most notably the computer vision (CV) and machine intelligence—which broadly includes artificial intelligence (AI) and machine leaning (ML)—that have achieved notable success in narrowly defined tasks under controlled environmental conditions. Yet, even for a highly advanced machine intelligence, it is a daunting challenge to fill all the gaps for reasons as follows.

Consider a blind person on the street with the walking cane to feel what is lying on his immediate front. When the cane hits a barrier or a stone, the tactile sensation alerts him about its hazardous presence, and the walker takes a detour around the object. The modern technology has addressed the same using the camera and a computing device. In such a device—one might call it ‘smart cane’, the machine intelligence is used to capture images and to detect and verbally alert about any notable objects lying ahead. More advanced device with a depth-sensing technique may give more precise information such as ‘a stone five meters ahead’, or being smarter, add its own interpretation of the situation: ‘a danger—five meters ahead’.

At this level, the information-transaction between the person and his immediate environment is no longer ‘atomic’ as it was termed for the traffic lights: an abridged but potentially value-added piece of information is delivered through the sensory substitution (of tactile in the case of walking cane, aural in the ‘smart cane’ device that substitutes for the visual). It is ‘abridged’ due to the verbal speech being a medium of narrow bandwidth: while hearing the particular speech, the walker is blocked off from others of potential interest. The smart cane device presumes that the walker's primary interest is aligned to safety—a sensible guess—and chose to give warning rather than the full literary description of the stone. It is therefore value-added if and only if its guess was correct.

But walking on a street involves myriads of other environmental cues that bombard the walker constantly. For a normal person, the street is a space of transportation, but also of pleasure and danger, social encounters and other diversions. On what purpose the walker is on the street at the given moment may narrow down the scope—irrelevant cues may be filtered out and the remaining prioritized, for example. Human brain evolved in such a way that even though the five sensory organs all operate in parallel and ingest innumerable threads of sensory stimuli, the vast amount of them are weeded out at early stages of the cognitive pathway, subconsciously or not. Yet the brain often makes use of the aggregate of seemingly insignificant cues before it draws any actionable conclusion out of the cognitive jumble. This results in situations where it draws a conclusion opposite to what it would have made had it considered only the most immediate cue out of many.

For example, the acquisition of the ‘hazard/danger’ cue in the form of the small bump ahead may save the blind walker from falling, clearly a hazard, but it may have been the opposite case if there was a bigger danger—a motorcycle lunging on his alternate path.

The example above illustrates the limitation inherent in operating a device on incomplete awareness of one's environment and context. Even if the device passes on a piece of information that supposedly carries the result of its high-level intelligence, it could be only tangential to the user's actual need, and while such information is verbally communicated to the user, it tends to black out the user's cognitive scope that is already impaired to begin with. The invention recognizes this as a critical flaw that prevents the prevalent mode of using the machine intelligence from reaching its full potential in elevating the quality of life of those afflicted with sensory deprivation.

The foregoing discussion in this section is to provide general background information, and does not constitute an admission of prior art.

### SUMMARY OF THE INVENTION

Portable Reading Device for Visually Impaired and Other Sensory Limited User Assistance.

It is an object of this invention to allow spontaneous access to both prepared and dynamically changing text for the visually impaired in their reading activities ranging from browsing a book to researching into multiple sources of textual data simultaneously.

It is a further object of this invention to describe a flexible system that is configured either as a stand-alone reading-device or as a multi-functional system that represents the novel data-ingestion, presentation and control functionality at cost and performance level that have not been met by existing methods for the demographic group of vision-impaired people.

It is a further object of this invention to extend the same benefit to the people in need of the same functionalities or their modifications as a result of momentary sensory deprivation or as the nature of the task, whether recreational or operational, demands enhanced and/or auxiliary cognitive capabilities.

It is a further object of this invention to allow the user of a suitably constructed embodiment of the invention to access and easily switch among the textual content of media of different types—including but not exclusively, printed books, periodicals, labels, building signs, street signs, text displayed or streaming on electronic monitors.

It is a further object of this invention to describe a generic ‘data ingestion’ layer that is to be the input part of various embodiments of the invention. The input layer may consist of an embodiment of just a single type or a combination of multiple types of data ingestion.

It is a further object of this invention to describe a method, denoted as the ‘mobile contact scanner’, that uses the miniature scanner element for scanning the small area under the user's fingertip, and for recognizing and extracting the character symbol in its center field of view as its content changes.

It is a further object of this invention to describe that the mobile contact scanner's functionality may be replicated in alternative forms of embodiments that produce an outcome equivalent to as described above. This includes methods that operate under direct- or quasi direct contact between the ingestion layer surface and the print medium, as well as contact-free bulk ingestion using a miniature camera.

It is a further object of this invention to describe one such form that employs a grid of optical sensors densely populating on the surface of the ingestion layer the size of which is just enough to cover a typical alphabet character in a book. The ingestion layer of the device may not touch the surface of the printed page, but hover over near enough for each optical sensor to discern the black or white states of its territory as the reflectance of illumination varies within each grid element.

It is a further object of the invention to describe that such an embodiment of the ingestion layer be equipped with lighting emitting element(s) or other optical constructs to provide adequate optical illumination for each passing character.

It is a further assertion of this invention that the mobile contact scanner's functionality may be replicated in alternative forms of embodiments that produce an outcome equivalent to as described above.

It is a further object of the invention to describe one such alternative embodiment of text ingestion layer that exploits the electrical impedance contrast between the inked zone and the pristine paper zone, as the typical ink, containing carbon, is conductive while the paper itself is insulating.

It is a further object of this invention that a concrete realization of what is generally called the ‘conversion layer’ hereafter processes the set of images scanned by the mobile contact scanner to output a time series of recognized Unicode characters. The logic of accurately determining the central ‘character’ in the stream is described later in the document.

It is a further object of this invention to describe a novel dynamically configured Braille (to be called ‘mobile electronic Braille’ hereafter). One side of this Braille unit is in contact with the user's body such as the tip of the index finger or other (extended) area that is sensitive to a tactile stimulus of a pattern of a particular embodiment of the invention. The other side interfaces with the entity that provides the input data in the form of the streaming train of characters or symbols. Each tactile pattern represents an item in the Braille set or other agreed-upon system that suffices to represent the given pool of codes for the given context.

It is a further object of this invention to define the primary function of the ‘mobile electronic Braille’ as thus: the presentation unit is to generate and present the stream of dynamically and electronically modified patterns that is sensed by the touch-sensitive surface of the user body part in contact with the said device surface.

It is a further object of this invention to describe that each Braille pattern corresponding to a given character in the stream be generated with adequate spatial and temporal resolutions for the given contact area and sensitivity of the chosen body part so that the trained person recognize the train of patterns as it is serially actuated on the same surface be recognized allowing the user to form a mental image of them as words and sentences. The body part remains in the same position, but the characters appearing and disappearing on the surface effectively create the illusion of the ‘ticker’ tape scrolling by.

It is a further object of this invention to describe that the matrix of tactile dots may be embodied using a variety of physical mechanisms as long as the pattern thus generated be recognizable by the trained and well-practiced user's touch-sensitive body part. A set of magnetic pins and their electro-mechanical control may be used to induce the sensation of touching a matric of vibrating dots; Alternatively, stimuli through imparting electric currents or ultrasonic jets in a coordinated series of spatiotemporal patterns may be employed to mimic the user's finger sliding across the embossed dots such as in the traditional Braille. The minimal requirement of the physical embodiment is set by the speed of each element's state transition and the spatial resolution of the sensation thus generated that may be distinctly felt by the chosen body part of the user in contact with the surface of the device.

It is a further object of this invention to describe a standalone embodiment that uses the ‘mobile electronic Braille’ as an auxiliary output device that attaches to the mobile or computer machine (or communicates with it wirelessly) as a subordinate/peripheral device as the reader of the screen content silently. Some computer and mobile device operating systems provide built-in services to help the visually-impaired user read through voice narration. In this invention, the electronic Braille receives from the computing machine a stream of Braille codes as the user's other finger on the free-hand touches and moves around the display screen. This operational mode is described as ‘BrailleOver’ (or ‘BrailleBack’) in analogy with the existing voice-narrated presentation of the similar nature practiced on major mobile systems. For example, ‘VoiceOver’ (iOS) and ‘TalkBack’ (Android), part of the ‘Accessibility’ suite of features on mobile phones. The user receives what he intends to read off the pointed-to spot on the screen on his fingertip (of the other hand of course) that is resting on the surface of the ‘BrailleOver’ device on which the stream of the Braille letters are streamed.

It is a further object of this invention to describe an embodiment of the presentation layer with an extended bar-like form factor long enough for presenting a line or block of refreshable Braille This form of presentation is suitable for use in conjunction with the ingestion layer that scans in the bulk of text at a time and is capable of process its content fast and is to dole out for presentation one line at a time. The user uses the device in the traditional fashion moving his finger across the surface of the bar. Lifting off one edge of the bar indicates the user is done with reading the line, and the device can be configured to use that as the cue to present the next batch of text automatically. The bar form factor allows extra controls placed on the side that the user uses to move around the ‘virtual’ page of the text as the device keeps pages of ingested text in cache memory to accommodate such functionality.

It is a further object of this invention to describe a composite embodiment that integrates the contact scanner input layer, the miniature processing layer and the electronic Braille presentation layer that attaches to a fingertip (designated as ‘thimble’ device hereafter for this particular form factor) or in a computer mouse like form, or other body parts. The difference between this ‘thimble’ embodiment and the ‘BrailleOver’ embodiment is that the former requires the image to character conversion as part of its logical algorithm to function independent of external computing logic such as the mobile phone.

It is a further object of this invention to describe the use of the integrated ‘thimble’ device as a portable reading device that generates the Braille pattern at the touching spot on any text-bearing surface as soon as the user puts his finger on it. Steadily scanning across in the horizontal direction, the dynamically generated Braille may be then read by the user. The built-in conversion logic and portable form-factor of this type of embodiment are therefore suitable for using the device to casually ‘read’ any printed matter, including the vast amount of old print books in the libraries, as well as menus in a restaurant, labels on products in grocery stores and pharmacies, etc.

It is a further object of the invention to describe that additional dots in the electronic Braille surface may be reserved and used for the purpose of presenting the state of variables other than the letters directly pertinent to the text. For example, a dot may represent the status regarding whether the user is moving the device in an adequate way for steady and accurate ingestion of the line of text.

It is a further object of this invention to describe the embodiment of the presentation layer in the finer grained form, allowing each pin to comprise multiple sub-elements each of which separately controlled between the “ON” and “OFF” activation status with fine temporal gradation. The sub-elements are manipulated by the control logic of the presentation layer in a spatiotemporally coordinated manner to create smoothly animated rendering of the Braille letters as they ‘flow’ across the presentation window, mimicking the sensation of the finger moving across the static Braille in its traditional use. Detailed objects of this extended functionality are further deliberated in the caption to FIG. 6.

It is a further object of this invention to describe that the pattern manifest on the surface of the ‘mobile electronic Braille’ is not restricted to those from the Braille set; while Braille set is the natural choice for the purpose of using the invention as assisting device for reading by the visually impaired person, it may also be a predefined set of arbitrary size in the form of a matrix of symbols that may consistently represent a finite set of options such as in the pull-down menus used widely in mobile devices and computers.

It is a further object of this invention to describe the embodiment of the mobile electronic Braille that also allows the feedback from the user back to its processing logic to modify its operating behavior or to activate a chain of actions on the master device to which it is attached by wire or wireless.

It is a further object of this invention to describe an embodiment of the basic building block of the user feedback in the form of gestures. A piezoelectric layer to detect the extra pressure (‘tap’) on the contact surface of the presentation layer is an example that may be used to build a set of gestures—a time series of ‘taps’ that can be detected and processed by the processing module of the device.

It is a further object of this invention to describe that multiple embodiments of the presentation can be configured to be used in a concerted fashion, e.g embedded in a glove, touching on fingers on one or both hand(s). Each unit is configured and assigned to perform specialized functions. In addition to the primary function of ‘Braille reading’, these include, not exclusively, common functionalities such as navigation, switching operational mode, invoking dictionary lookup, etc. Possible form-factors of each unit include rings, arm- or head-bands, bracelets, vests, etc.

It is a further object of this invention to describe that multiple embodiments of the data ingestion can also be configured to work in concert. In addition to the contact scanning mode, the invention envisions the use of a video camera mounted on the user's body or an eyeglass to optically capture image frames of the textual scene. Each frame is used first to recognize the user's fingertip within the scene as the pointer to the zone of immediate interest in the text. In this ‘pointed browse node’, the conversion layer extracts the characters (word or a line of text) in the vicinity of the area pointed to by the fingertip, and sends them to the presentation layer as a stream of Braille code so that the user ‘read’ the text. Alternatively, the pageful of converted text resides in memory of the device. While in this mode, successive movements of the fingertip captured within the page is tracked (1101,1102), its position mapped to the corresponding location in the decoded text block (1103, 1104), and used to retrieve the corresponding letter or word (or line) from memory to be delivered to the user's other hand/finger in contact with the presentation layer device. (1106)

It is a further object of this invention to describe that the camera captured image is also used for decoding the whole screenful of text via optical character recognition logic (OCR) and at user's preference, the presentation may be delivered in the passive narrative mode. In this mode, the user's finger (if so used) remains static on the electronic Braille surface as the narration progresses in the form of changing Braille pattern under it one character at a time.

It is a further object of this invention to describe that the basic control such as speeds, pause, stop, etc in the narrative mode is actuated using the same tactile feedback mechanism described earlier.

It is a further object of this invention to describe an embodiment with an extra capability of tracking user's body-part metrics. For example, if the image is ingested via a video camera mounted on the user's head or an eyeglass, or if the whole embodiment of the reader itself is part of the wearable computing device e.g. a pair of eyeglasses or a goggle, the processing layer takes advantage of the physical orientation of camera as it is interpreted as cues from the user move the reading head across the medium.

It is a further object of this invention to describe that the intuitive switching between the passive narrative mode and the pointed browsing mode can be achieved via detection of the fingertip in the scanned image when the video camera is used. Touch pressure gestures on the presentation device may also be used to control the logistics of the ‘reading’ progression.

It is a further object of this invention to describe a multiplex embodiment that takes advantage of the wide range of combinatorial manifestations as each of the ingestion-, conversion-, presentation-, and feedback-layers offer a variety of options in its form-factor and operational mode.

It is a further object of this invention to describe the method to help the visually impared reader, in his line by line reading of printed text using its embodiment, accurately locate the next line. In traditional Braille, the reader uses both hands, one (the reading head) for reading the current line of text, the other (the anchor) for marking the line-to-line progression. When the end of the line is reached, the reading-head moves to the beginning of the next line using the anchor as the guide for its landing. The invention uses the quick preparatory vertical scan to register the first few characters of each line and keep them in memory as the reference. When the user moves the reading head of the ingestion layer on the next line, the logic analyzes its registry with respect to the pre-scanned reference and issue guidance when the landing is off the correct mark.

In order to achieve the above objects, the present invention provides a device compensating limits of humans senses, comprising a receiver receiving information in a first sense, a converter converting the received information into information in a second sense and a presenter that presents the converted information.

The first sense is the vision and the receiver receives visual information comprising texts, wherein the second sense is auditory sense or tactile sensation, wherein the receiver comprises an ingestion layer that ingests information from a target object.

The ingestion layer is adapted to be held by a finger and has comparable size, wherein the ingestion layer recognizes and extracts the character symbol in its center field of view as content of the visual information changes.

The ingestion layer is adapted to make direct- or quasi direct contact between a surface of the ingestion layer surface and a print medium.

The ingestion layer receives the visual information remotely from a print medium.

The ingestion layer comprises a grid of optical sensors densely populating on the surface of the ingestion layer the size of which is just enough to cover a typical alphabet character in a book.

The ingestion layer comprises a sensor that exploits the electrical impedance contrast between the inked zone and the pristine paper zone.

The converter comprises a conversion layer that processes the set of images scanned by the ingestion layer to output a time series of recognized Unicode characters.

One side of the sensor of the ingestion layer is adapted to be in contact with the user's body such as the tip of the index finger or other (extended) area that is sensitive to a tactile stimulus of a predetermined pattern, wherein the other side of the sensor interfaces with the entity that provides the input data in the form of the streaming train of characters or symbols.

The presenter comprises a presentation layer that is to generate and present the stream of dynamically and electronically modified patterns that is sensed by the touch-sensitive surface of the user body part in contact with the device.

Each Braille pattern corresponding to a given character in the stream is to be generated with adequate spatial and temporal resolutions for the given contact area and sensitivity of the chosen body part so that the trained person recognize the train of patterns as it is serially actuated on the same surface be recognized allowing the user to form a mental image of them as words and sentences, wherein the body part remains in the same position, but the characters appearing and disappearing on the surface effectively create the illusion of the ‘ticker’ tape scrolling by.

A set of magnetic pins and their electro-mechanical control are be used to induce the sensation of touching a matric of vibrating dots, wherein alternatively, stimuli through imparting electric currents or ultrasonic jets in a coordinated series of spatiotemporal patterns are employed to mimic the user's finger sliding across the embossed dots such as in the traditional Braille, wherein the minimal requirement of the physical embodiment is set by the speed of each element's state transition and the spatial resolution of the sensation thus generated that may be distinctly felt by the chosen body part of the user in contact with the surface of the device.

The presentation layer comprises an extended bar-like form factor long enough for presenting a line or block of refreshable Braille.

The additional dots in the electronic Braille surface are reserved and used for the purpose of presenting the state of variables other than the letters directly pertinent to the text.

The presentation layer in the finer grained form allows each pin to comprise multiple sub-elements each of which separately controlled between the “ON” and “OFF” activation status with fine temporal gradation, wherein the sub-elements are manipulated by the control logic of the presentation layer in a spatiotemporally coordinated manner to create smoothly animated rendering of the Braille letters as they ‘flow’ across the presentation window, mimicking the sensation of the finger moving across the static Braille in its traditional use.

The user feedback is provided in the form of gestures, wherein a piezoelectric layer to detect the extra pressure (‘tap’) on the contact surface of the presentation layer, wherein the gesture comprises a time series of ‘taps’ that can be detected and processed by the processing module of the device.

A video camera mounted on the user's body or an eyeglass to optically capture image frames of the textual scene, wherein each frame is used first to recognize the user's fingertip within the scene as the pointer to the zone of immediate interest in the text, wherein in this ‘pointed browse node’, the conversion layer extracts the characters (word or a line of text) in the vicinity of the area pointed to by the fingertip, and sends them to the presentation layer as a stream of Braille code so that the user ‘read’ the text.

Alternatively, the pageful of converted text resides in memory of the device, wherein in this mode, successive movements of the fingertip captured within the page is tracked, its position mapped to the corresponding location in the decoded text block and used to retrieve the corresponding letter or word (or line) from memory to be delivered to the user's other hand/finger in contact with the presentation layer.

An extra capability of tracking user's body-part metrics is utilized, wherein if the image is ingested via a video camera mounted on the user's body, the processing layer takes advantage of the physical orientation of camera as it is interpreted as cues from the user move the reading head across the medium.

At the intuitive switching between the passive narrative mode and the pointed browsing mode is achieved via detection of the fingertip in the scanned image when the video camera is used, wherein touch pressure gestures on the presentation device is also used to control the logistics of the ‘reading’ progression.

The line by line reading of printed text accurately locates the next line, wherein when the end of the line is reached, the reading-head moves to the beginning of the next line using the anchor as the guide for its landing, wherein the quick preparatory vertical scan is used to register the first few characters of each line and keep them in memory as the reference, wherein when the user moves the reading head of the ingestion layer on the next line, the logic analyzes its registry with respect to the pre-scanned reference and issue guidance when the landing is off the correct mark.

The ingestion of its original form, i.e. a set of black pixels arranged in a certain pattern, is ‘ingested’ via an optical scanner or a camera device, wherein it is then passed on to the ‘conversion layer’ in which a series of computational operations are performed on the image, wherein the operations include the standard ‘computer vision’ (also called ‘image analysis’) methods, wherein for each character found, the conversion layer ‘converts’ (or maps) its symbolic content to its counterpart appropriate for other available sensory channels, wherein the presentation layer controls how the Braille letter is physically manifested to be detected by the reader.

The ingestion layer delivers a frame of captured image along with the metric information of the image acquisition, wherein the metric information includes the mode of ingestion, scanning speed, quality of operation including alignment of the scan direction and the lines of text, proper registry of the scan head and desired spot in the text.

The presentation layer describes ways to physically render the converted code in the tactile form, wherein the layer comprises an M by N grid arrangement of pins with dynamically adjustable height.

The presentation layer comprises a fine grained grid of dynamically deformable miniature elements, wherein whether the embossment is rendered via physical deformation, vibration, electrical current or ultrasonic jet injection, when each element is made of finer components, the subunits are manipulated in a spatiotemporally coordinated manner to create a smooth animated motion of the pattern to the left as the sequence of frames indicates.

The ‘thimble’ type contact scanning reader device comprises an upper cover and a lower part that reveals a hole into which the user inserts his finger and let its bottom in contact with the presentation layer which delivers the stream of dynamic Braille to be felt, wherein the ingestion layer comprises the contact scanner and illuminating element, and it is placed directly under the presentation layer, or is located further forward in the device which allows its own size to accommodate larger scanning area, wherein the bottom of the presentation layer comprises a pressure-sensitive element for the user to gently press on to issue a useful action relevant for the logistics of the situation, such as switching mode (letter- or word-mode), presentation channel (from tactile to audio), or toggle to the ‘select-to-look-up-dictionary’ mode.

A camera mounted on the eyeglasses is used as primary ingestion layer, wherein the pageful of text may be ingested and converted, ready to be delivered piecemeal to the presentation device, wherein the user uses the other hand mainly for navigating the ‘reading head’, wherein the camera continuously tracks the fingertip position and extracts its corresponding position in the ‘reference’ text stream stored in its memory, and sends immediately the letter or word or the cluster of letters in its vicinity to the presentation module.

In addition to the primary presentation layer as manifested in the dynamically refreshable Braille pad, an area is also dedicated to receive the user's gesture, wherein elsewhere in the text, the Braille layer senses gestural movement of the finger touching it.

The reading head is moved for two alternative ingestion modes, wherein the top panel uses a camera mounted on the frame of the eyeglasses to ingest the whole or a part of the page pointed at by the user's finger, wherein the process begins with a full page capture when the user turns a page, wherein the whole image is analyzed and converted to digital text that is to be stored in memory of the conversion layer, wherein the device goes into the mode of continuous tracking of the finger as successive frames of captured image arrive, wherein the location of the fingertip is mapped to the location in the digitized text stream, and that defines the current reading head, wherein when the fingertip location is changed, the new batch of relevant text is transmitted to the presentation device.

The presentation layer is distributed over multiple body parts, such as all fingers on a hand.

Direct imaging of the area is performed using a miniature pin-hole camera, and followed by a dithering image process, yielding an N by N, black (1) and white (0) digital rendition of an alphabet character or part of it, if present, in its central field of view.

Depending on whether the usage context is (A) for reading the page in a book or (B) for navigating in the street, the presentation layer opts for a different mode of presentation.

The user's finger is tracked to interpret his navigational intent or to invoke various tasks as part of the reading/browsing activity.

Multi-sensory Environmental Scanner: In another embodiment, the presenter comprises a presentation layer that is to generate and present the stream of dynamically and electronically modified patterns that is sensed by the touch-sensitive surface of the user body part in contact with the device.

The receiver ingests the full audio or visual sensory stimuli, and takes the portion that is blocked for the sensory deprivation of the user, wherein the converter extracts environmental cues contained therein by applying machine intelligence logic and makes trans-sensory conversion to their synthetic representation.

At any given moment, the raw primary data and the converted cues are consolidated and presented through the user's primary sensory channel.

Scene injection comprises a first category of information recognised by the primary (i.e. fully functioning) sensory organ, and a second category of alternative ingestion devices that substitute for the user's deprived sensor.

The media data ingested through the categories are analyzed to detect discrete, and noteworthy, environmental cues, and the extracted cues are then converted to their trans-sensorial counterparts so that the user senses them through functioning sensory organs, wherein the converted cues are sub-categorized as AM (Auxiliary Machine-Intelligence cues), AT (Auxiliary Trans-sensorial cues), and T (Tactile cues), wherein AT and AM are delivered through the user's primary sensor and T is through his tactile sensor.

The cue comprises a vertical thread, which contains dots and vertical lines, wherein the dot represents a trans-sensorial cue that the device logic identified as a notable environmental cue at a particular time, wherein objects and events last for duration are represented as the vertical lines.

The Primary Raw (PR) strand stands for the environmental data adapted to be ingested directly through the user's fully functioning sensory channel in raw form, wherein the PR strand may be choked if the user wants to focus exclusively on the cues synthesized by the device (AM, AT).

The strand can be dynamically controlled to pull the strand to the fore or push it to the background, whereby avoiding sensory overload that leads to more confusion than assistance, wherein the four strands: AT, T, AM, PR can be controlled based on the environment dynamic and the user's intention.

For aural cues, the volume of the sound or the intensity of synthesized stimuli for tactile cues is the way to control the weight.

For visual cues, the weight means manipulating attributes of their visual representation, which comprises their alpha values on the screen, color-vibrancy, sizes (for an icon-based rendering), or styles (plain vs. bold faces if the cues are to be rendered as text).

The device monitors the presence of an obstruction within the volume of a cone in the user's moving direction or around his body, wherein continual availability of these ‘boundary’ or ‘perimeter’ information allows the invention to define the special type of environmental cue, designated as the safety bubble breach cue.

The converted trans-sensory cues are then delivered to the user through his available sensory channel and join the cognitive pathway in real time.

For the visually impaired, a video camera with depth sensing capability (or a set of them) attached to the user's body part substitute for his eyes, wherein the device ingests the visual ‘scene’ of the user's immediate environment, extract relevant visual cues from the scene and convert them to their aural (and also tactile) counterparts, wherein the delivery of the trans-sensory (converted) cues is through the 3D-audio capable headset and body-worn tactile sensors.

For the visually impaired, an ultrasonic device(s) with an echo-generation and detection capability is attached to the user's body part, wherein the device monitors the presence of an obstruction within the volume of a cone in the user's moving direction or around his body, wherein continual availability of these ‘boundary’ or ‘perimeter’ information allows the invention to define the special type of environmental cue, designated as the ‘safety bubble breach’ cue, wherein the cue acquires a breachment flag whenever an obstruction is projected to invade the user's prescribed bubble.

The ‘personal safety bubble’ cue is converted to the trans-sensorial counterpart as an aural and/or a tactile stimuli, presented to the user to intuitively communicate its location, nature, and imminency, wherein the severity or imminence of the breach is indicated by the intensity of the stimuli, wherein the location of the breach point is indicated by the lateral position of the stimuli in the tactile theater coordinated with an audio beep with distinct pitch that indicates its vertical position.

An equivalent ‘safety bubble’ functionality is obtained from the logical analyses of the images captured by depth sensing video camera(s).

The primary substitute for the deprived hearing sense is a stereophonic microphone or an array of directional microphones attached to the user's body or carried object, wherein the delivery of the trans-sensory (converted) cues is primarily through haptic stimuli and, if available, through an augmented-reality goggle or eyeglasses that is capable of showing icons or other visual cues at appropriate location on its screen.

The raw ‘scene’ is defined as a set of consecutive image frames and the audiogram captured during the window of time preceding the given moment, wherein the duration for the visual and the aural capture may differ reflecting the fact an event of interest may last long or short depending on its nature, wherein within each scene, there exist numerous identifiable environmental cues, wherein there are events that arise from motions and changes in their attributes, wherein it also includes the ambience-types such as the personal safety bubble cue.

To communicate the bird's eye view of the environment to the user in real-time, the device identifies the discrete elements in the scene to construct the coarse grained representation, wherein each object is identified at its most generic level and with a small set of vital attributes. [Auxiliary Trans-sensory Strands of the Braid]

The part of the ingested ‘scene’ captured by the device that are inaccessible to the user is funneled to the machine intelligence unit that extracts cues of depth or higher-level of intelligence, adds further value in depth and scope, and contributes them to the cognitive pathway. [Auxiliary MI Strand of the Braid]

The manifestation of the ‘deep’ cues as generated by the high-level machine intelligence is primarily in the verbalized speech (for visual impaired) form or in the text that scrolls by superimposed on the designated part of the augmented-reality viewing device.

The user's available sensory channel is multiplexed, wherein first, there are auxiliary channels that carry both the trans-sensory and the machine-intelligence generated cues each of which generates the content at its own pace dictated by the nature of the logics involved, wherein secondly, there is the primary channel that carries the raw cues that the user is naturally capable of sensing in the background. Primary Raw Strand of the Braid]

The delivery of contents in each of the channels above does not block each other, i.e. their operations proceed asynchronously, but the user maintains the full and easy control of enabling or disabling each of them at any given moment.

At more graded control of the relative weight is distributed among the multiplicity of the channels (among the primary- and auxiliary channels), wherein the control is effectively the way for the user to shift his focus from one to another layer of his environment.

The first is achieved by tightening or loosening the filtering criteria in the trans-sensory conversion, wherein by limiting detection of cues or weeding out what is deemed less critical, the number of cues entering the auxiliary channels diminishes and their presence recedes from the user's cognitive awareness.

The second way is to control the intensity of their presentation, wherein the primary channel's volume may be reduced by an active noise-canceling logic on the hearing device in the case of the visually impaired person, wherein for the hearing impaired, the AR-type glass reduces the pass-through view, wherein the auxiliary contents become more prominent by their enhanced intensity likewise.

The control that shifts the user's focus is administered by the on-board machine-intelligence logic based on the set of heuristic rules dictated by the operational context of the device, wherein it is also controlled during operation by the user's engagement with a suitably designed knob or a button on the device.

For a feedback mechanism to access more in-depth information on a particular cue, the device recognizes a set of prescribed user gestures, wherein the gesture is used for the user to select a particular cue item as displayed in his trans-sensory theater, wherein upon the user's affirmation, either through a prescribed gesture or by pressing the designated button, the device fetches further detail on the cue from its machine intelligence logical unit and presents it in the theater.

At regular intervals the system aggregates the active trans-sensory cues and renders them aurally (for the visually impaired) or visually (for the hearing impaired) and, common to both cases, via tactile means depending on the nature of the cues.

The trans-sensory process is performed as a blackbox with the source intake side (the deprived sensory channel), and the output side that faces the target channel(s), wherein the source comprises a stack of video frames accumulated over the preceding few seconds—if it is for the visually impaired user, wherein for the hearing-impaired user, the source to be translated is the audio stream captured by the microphone over the few seconds up to the given moment.

The trans-sensory translation does not imply literally the direct translation between the volume of RGB pixels and the acoustic wavelets, wherein it is mediated through machine intelligence operations (computer vision on one hand, sound recognition on the other hand) to extract a manageable number of relevant objects (and their attributes), wherein the device then maps them onto the ‘palette’ of predefined cue-objects to output them to the target channel.

A cue-object represents something that is perceived as a discrete entity at lower rungs of the human cognitive pathway, wherein it is hierarchical, wherein each carries attributes such as its basic metrics.

The amount of all possible attributes of objects and events encountered on a street easily overwhelms one's cognitive capacity. Therefore, the invention describes that it uses a systematic organizational method for alleviating the sensory overload problem. The method is informed by how humans deal with the pristine sensory input loaded with redundant and irrelevant clutters by using selective focus, adjustment of granularity, mental blockout, etc.

Each image frame that constitutes a visual scene is analyzed by applying a set of well established computer vision techniques to identify objects of interest in the scene as well as their location with respect to the user in the three dimensional space.

A set of rules define and use operational presets to dynamically adapt the scope of the “palette” to the specific purpose or situation for which the invention is used, wherein a relatively simple preset may need a small set of cue-objects and their attributes, but others may require an expanded set.

The operational preset is a software arrangement that modifies the behavior of the device logic in constraining the scope of trans-sensory conversion, wherein the system filters out or includes a set of environmental cues in its workflow depending on the preset chosen dynamically by the user if he is using the embodiment of the invention designed for general purposes, wherein it is also equally possible that the designer (or manufacturer) of the particular type of embodiment tailors the scope of included presets in conformance with the purposes and hardware capabilities of the device.

The operational preset also defines the form and contents of the trans-sensory cues, as there are more than one way to translate, for example, the visual image of a dog as a symbol to the soundbite form.

The form and the scope of presets are constrained by the uniqueness and compactness of the trans-sensory mapping between cues, wherein the user's physiological condition, his aesthetic preferences, and the open-ended nature of all possible operational contexts would favor flexibility and customizability.

Ultrasonic device(s) with an echo-generation and detection capability is attached to the user's body part, wherein the scope includes the presence of impending hazard such as a low hanging tree branch or an abnormal road condition in the user's forward path, wherein the cue acquires a breachment flag whenever such an obstruction is projected to invade the user's prescribed bubble.

The ‘personal safety bubble’ cue is converted to the trans-sensoral counterpart as an aural and/or a tactile stimuli, presented to the user to intuitively communicate its location, nature, and imminency, wherein the severity or imminence of the breach is indicated by the intensity of the stimuli, wherein the location of the breach point is indicated by the lateral position of the stimuli in the tactile theater coordinated with an audio beep with distinct pitch that indicates its vertical position to give a specific example, wherein in the 3D audio theater, the breach zone is presented in the form of a waxing and waning of the localized humming sound.

The raw ‘scene’ is defined as a set of consecutive image frames and the audiogram captured during the window of time preceding the given moment, wherein the duration for the visual and the aural capture may differ reflecting the fact an event of interest may last long or short depending on its nature, wherein within each scene, there exist numerous identifiable environmental cues: objects, events, ambience-types.

The delivery of contents in each of the channels above does not block each other, i.e. their operations proceed asynchronously, but the user maintains the full and easy control of enabling or disabling each of them at any given moment.

The device recognizes a set of prescribed user gestures (detected through the on-board gyroscopic sensor placed at an appropriate place in his body).

The central Auxiliary Machine-Intelligence Cue (AM-Cue) detection loop (or module) imbibes the data from three distinct ways, wherein one source of the ingredient is from the primary sensor, wherein in addition to adding more value that is only possible through the machine/network analytics, it can be used to correlate with the other sensory aspects of the same origin, and thereby enhance the quality of the cues that have interpretative content such as an event or mood, wherein the device provides the portion of the primary sensor input, a queue-full of alternate sensor input, as well as the trans-sensory cues that its light-weight conversion layer has identified.

At any given moment, the material to compose the final rendering enters the logic unit from two sources, wherein one is the user's primary (functioning) sensor and the other is the auxiliary cue pool which is a temporary depository of all cues generated by the preceding logic processes using the trans-sensorial conversion and to be consumed at this stage, wherein some cues, even though based on the shared set of contemporaneous raw material, may get generated by the conversion logic and arrive at the Cue Pool with differing amounts of time lag, wherein the sorting unit continually runs a book-keeping operation to order, cross-correlate, and eliminate redundancy among them, wherein the sorting unit then dispatches each of the surviving trans-sensory cues to the relevant strand, wherein the renderer unit then renders them using methods such as screen-rendering, audio-synthesizing and haptic stimuli generation, wherein the rendering of all cues for the unit time step of the rendering or device refreshing cycle occurs two-fold: One is the layers of the user's primary sensor canvas and the other is the user's tactile sensor canvas if the user/device employs it, wherein from these two sensory canvases, the curated environmental data and cues enter the user's brain that takes appraisal of them as a whole and takes action.

The context for the operation of the device may be conditioned by applying a predefined preset that the device maker or the user chooses, wherein the preset is essentially a container for parameters that pre-conditions the trans-sensory conversion logic.

Processing logic applies the set of logical steps that include identification of noteworthy environmental cues, namely objects present and events happening in the scene, wherein it also derives their attributes deemed relevant by the preset—such as the item's location in 3D, velocity, correlates with other cues, if multiple ingestion devices allow such an inference for enhanced accuracy, wherein these cues are then converted to the user's primary sensory form (aural for the vision-impaired) and fed into what is termed ‘Auxiliary Trans (Sensory) Strand’ of the presentation theater in the invention.

The vision data stream is processed more extensively to obtain higher level information as well as finer details about them, wherein the raw video input is channeled into what is termed ‘Auxiliary Machine Intelligence (MI) Strand’ of the presentation theater in the invention, wherein on this channel, advanced computer vision (CV) and machine learning (ML) operations are applied on-board or farmed out to external service providers and obtain the analytic results via asynchronous communication to avoid hindering the latency-averse Auxiliary Trans-sensory and Tactile Strands.

Placement of the identified objects in the 3D real space and their representation may use either the absolute- or the relative-coordinate system, wherein the device may dynamically switch between the relative and the absolute modes either on users command or autonomously if the device logic is capable of detecting the change of operational context by advanced analytics of the monitored environment.

The output comprises a bundle of multiple strands, each of which is a stream carrying the environmental data in various forms, wherein at a given moment, the user watches (hearing-impaired) or hears (visually-impaired) the time slice of the bundle, wherein easy shifts from one stand to another are allowed by two mechanisms, wherein one is by twisting the bundle and the other is by pinching the strand, wherein by ‘twisting the bundle’, the device brings one strand over (i.e. forward) others, wherein ‘Pinching’ a strand effectively throttles the output on the affected strand (this applies only to the auxiliary strands that carry synthetic cues) by changing the filtering criteria for the cues sent to it.

Each generic class defines the set of attributes. There is a set basic attributes that all classes mandate for their instances.

Continuous dynamical attributes of objects such as distance, location, size, velocity are inferred from the depth-field map (if available) and tracked using the optical flow logic.

If objects of the same class are found in close proximity to each other, they are lumped and assigned to a crowd object instead.

The echo bouncing off the obstacles is captured by an array of hyper-sensitive microphones and further optimized—cleared, amplified, transformed, and cross-analyzed with the contemporaneous cues in all strands, wherein it is then incorporated into the Auxiliary Trans-sensory Strand in a more user-friendly form, thereby bringing the benefits of augmented-echolocation to the user who is not highly skilled in the traditional echolocation technique.

### BRIEF DESCRIPTION OF THE DRAWINGS

The accompanying drawings illustrate the best embodiments of the present invention. In the drawings:

FIG. 1 is a schematic illustration showing a human being's reading process;

FIG. 2 is a schematic illustration showing an ingestion layer, a conversion layer and a presentation layer;

FIG. 3 is a schematic illustration showing different types of the text source, a contact scanner, a camera, and a digital text;

FIG. 4 is a flow diagram showing he logic flow of the conversion layer;

FIG. 5 is a schematic illustration showing that the presentation layer physically render the converted code in tactile form;

FIG. 6 is a schematic illustration showing the tactile scanning of the Braille and its counterpart as realized in the presentation layer;

FIG. 7 is a schematic illustration showing a ‘thimble’ type contact scanning reader device;

FIG. 8 is a schematic illustration showing a modular form factor that separates the ingestion/conversion layer and the presentation layer;

FIG. 9 is a schematic illustration showing a camera mounted on the eyeglasses as the primary ingestion layer;

FIG. 10 is a schematic illustration showing that the presentation device accommodates the user feedback;

FIG. 11 is a schematic illustration showing the process of moving the reading head for two alternative ingestion modes;

FIG. 12 is a flow diagram showing logic flow through which the user ‘trains’ the system to set up the virtual context in its memory;

FIG. 13 is a schematic illustration showing the aspects of the text block in a page;

FIG. 14 is a schematic illustration showing the heuristics that the contact scan methods use in ingesting and identifying the stream of characters;

FIG. 15 is a schematic illustration showing two types of impaired senses;

FIG. 16 is a schematic illustration showing an operational context that the present inventions assists its user with;

FIG. 17 is a schematic illustration showing a presentation theater;

FIG. 18 is a schematic illustration showing dynamic control of the presentation theater;

FIG. 19-a is a schematic illustration showing how the trans-sensorial cues are presented to the visually impaired user in a typical street situation;

FIG. 19-b is an illustration similar FIG. 19-a for the hearing-impaired user;

FIG. 20 is a flow diagram showing the logic flow for the invention from the sensor-hardware to the presentation theater;

FIG. 21 is a flow diagram showing how the trans-sensory conversion logic works in the trans-sensory conversion block;

FIG. 22 is a flow diagram showing advanced machine intelligence logic workflow;

FIG. 23 is a flow diagram showing logic that consolidates all environmental data and renders them; and

FIG. 24 is a schematic overview of the logic flow that the invention follows in using the environmentally generated motional metrics in the game's narrative and control logic to enhance the player's immersion.

### DETAILED DESCRIPTION

Portable Reading Device for Visually Impaired and Other Sensory Limited User Assistance.

The invention is a system whereby a text can be converted into a stream of the Braille or other types of encoded signals to be delivered in a trans-sensory manner and allows its user exercise control over various aspects of its workflow.

A set of portable apparatuses is described as an embodiment of the system that allows a visually-impaired, permanently or momentarily, person to ingest a textual element and have the processed information delivered via the tactile/haptic output apparatus in real-time. The control logic and various ways to use the system are described.

The invention also describes an embodiment in the form of a wearable apparatus that allows the visually impaired user to casually shift her focus of interest among various parts of the textual body—in the way a reader may quickly browse a page in the book by jumping the focus point from a paragraph to another.

The scope of the invention includes but is not limited to the usage context for the visually-impaired but extends to recreational and operational activities in which the amount and speed of textual information overwhelm the nascent human capacity to ingest, interpret and arrive at an actionable conclusion in real-time.

The invention addresses aspects of difficulty that arise in the propagation of textual information to the recipient who is visually impaired or with limited sensory capacity constrained by the nature of the task he or she is momentarily engaged in. To give a schematic description of the abstracted layers involved, the flow of the textual information starts from the ingestion layer of the source (upstream) content such as an existent print book, a street sign, or a screenful of digital text on a mobile device. After the conversion logic process (conversion), it eventually reaches the downstream presentation layer, then finally registers with the user's cognitive circuit (sensor and brain). In a person with vision intact, the whole chain of events occurs between the retina and the optic nerve, a substitute system would take on the roles in different disguises for the vision-impaired person.

The ideal embodiment of the invention in this regard would require availability and flexible, on-the-fly control of various text ingestion channels, efficient data conversion logic, and novel feedback and control methods without compromising the speedy reading.

For the ingestion, the invention's scope includes a novel contact-scanning device (thimble) that works as a standalone input device as well as in cooperation with other channels based on the image-to-OCR and the innate digital sources. For the presentation, the invention includes a novel embodiment of the Braille-inspired portable/wearable/gesture-capable entity. Various embodiments of this are described herein.

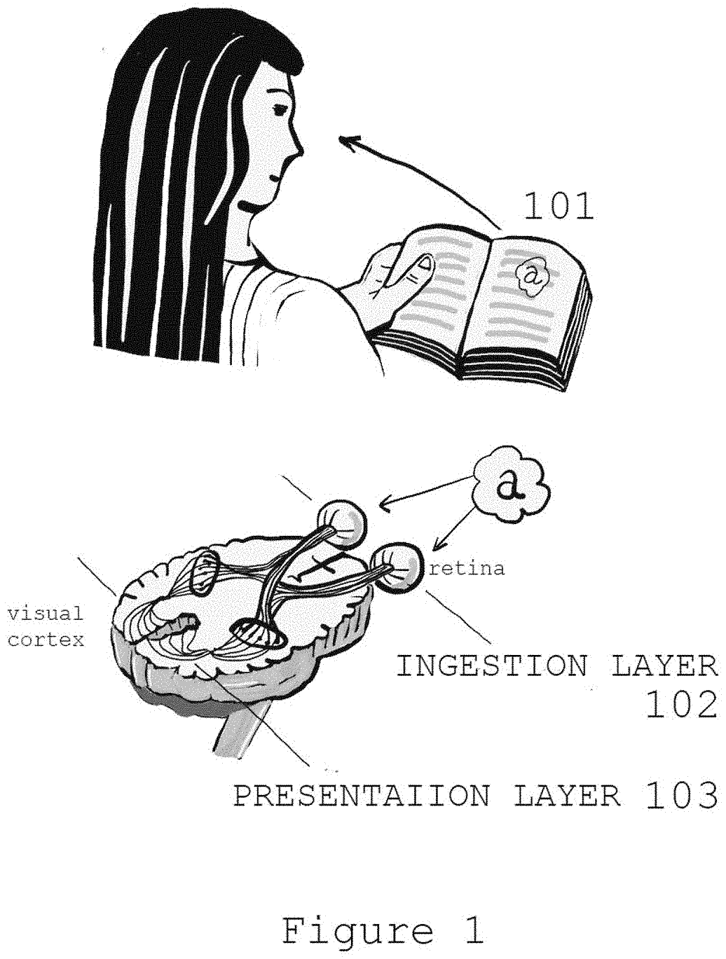

FIG. 1: When one reads a book, the eyes move the focus from one area to the next (101), ingesting the part of the image through the retina (102). Propagating through the optic nerve bundle, the image—rather the particular arrangement of black dots—is ‘presented’ (103) to the visual cortex near the rear end of the brain. There, the particular pattern of dots is ‘processed’ and its symbolic content, if discernible, is extracted—the letter ‘a’ in the figure—and joins the deeper reaches of the cognitive stream. The whole series, repeated letter after letter, constitutes what we call the ‘reading’ experience.

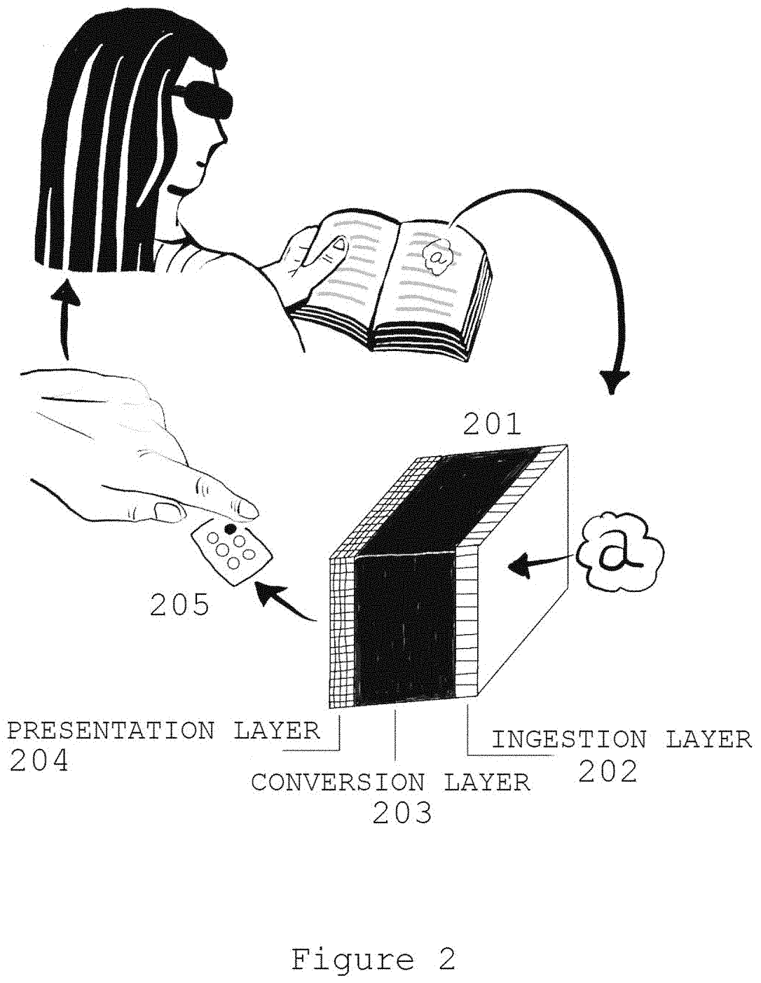

FIG. 2: This figure introduces the core elements (layers) of the invention in a schematic way. For a visually impaired person, ingestion of a letter ‘a’ on a printed page should find its way to the deeper layers of the ‘reading’ process via other sensory channels. The ingestion of its original form, i.e. a set of black pixels arranged in a certain pattern, is ‘ingested’ via an optical scanner or a camera device. (202) It is then passed on to the ‘conversion layer’ (203) in which a series of computational operations are performed on the image. The operations include the standard ‘computer vision’ (also called ‘image analysis’) methods such as de-noise filters, crop, scaling, object identifying, character recognition, etc. For each character found, the conversion layer ‘converts’ (or maps) its symbolic content (‘a’) to its counterpart appropriate for other available sensory channels. Both auditory and tactile channels are in the scope of this invention. Note that, in doing so, the conversion layer also performs some of the cognitive process—recognizing the symbol ‘a’ in the image of dots—that occurs after the image enters the visual cortex in the normal reading process of FIG. 1. The ‘conversion’ layer finally presents the converted representation (e.g. the Braille letter for ‘a’ for the tactile channel). The ‘presentation’ layer (204-205) controls how the Braille letter is physically manifested to be detected by the reader.

Note that, for the reader, the real ‘ingestion’ begins at that point (205), but in the form of a tactile pattern of a Braille letter that faithfully substitutes for the printed image and its symbolic content. From there, the cycle of FIG. 1 is mirrored biologically and through the tactile channel instead of the visual cortex.

The invention describes various ways to present the converted symbols (Braille or other prescribed representations) generated dynamically to provide ‘reading’ access to randomly selected parts of virtually any printed material in real time and without compromising the readers cognitive capacity. It is also noted that the layers may be embodied as an autonomous, integrated device, or in manifestations of modular arrangement—for example, the ingestion and the presentation layers may be sandwiched but attached to a separate computing unit where conversion and processing operations are done. A separate ingestion layer in the form of a featherweight magnifying glass may communicate wirelessly with a touch pad-like unit that houses the computing and the presentation modules.

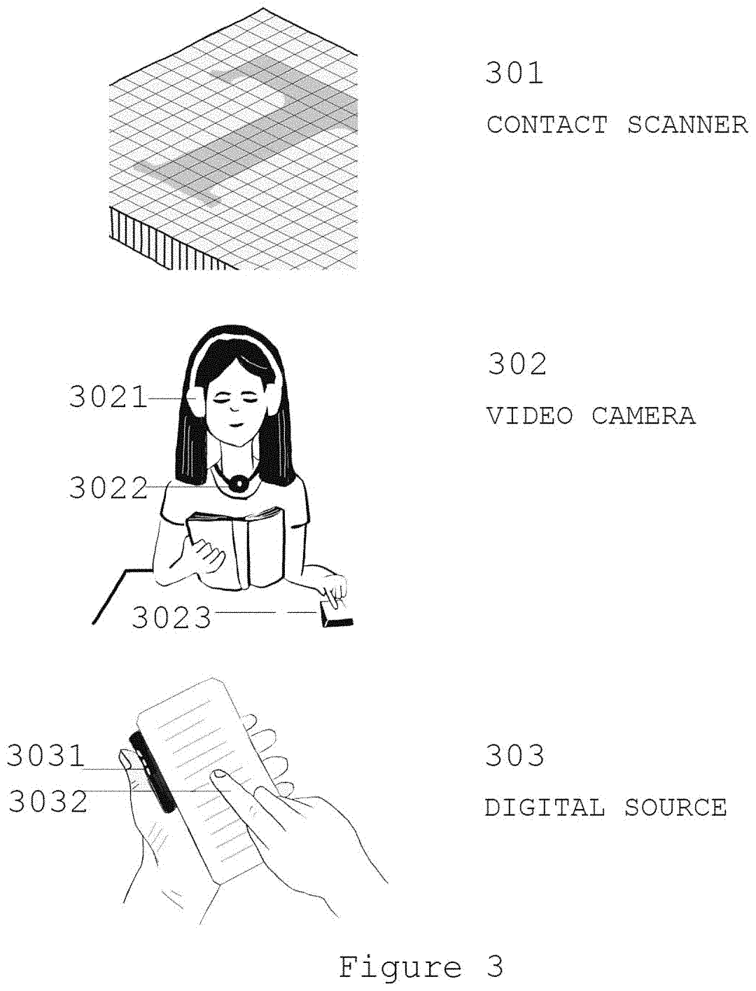

FIG. 3: This figure shows the types of the text source. The invention describes the portable ‘contact scanner’ ingestion device that comprises the dense grid of optical sensors (301) of the size large enough to cover one or more lines of text in height and a few letters in width in a book. The size may be bigger for more accurate reading at the expense of reduced portability and more computing resource requirement. The grid is designed to be in direct or near-field contact with the surface of the print matter as the user moves it along the line(s) of text at a normal reading speed. Each element in the rectangular grid detects the brightness of the spot that underlies it. At a given moment, (301 shows part of an example 18×36 elements) each cell reports a value of 1 or 0 based on the detected signal to threshold ratio, (about 50 elements covering the letter “T” will report 1's in this example). A reading at time t generates the ‘frame’ consisting of black/white dots and it is passed on to the ‘conversion’ layer. The embodiment may use a global illuminating layer to provide reliable reading under varying ambient lighting conditions.

The second type of ingestion uses a camera that is mounted on the user's body (3022 showing an example of the pendant/necklace-like form). The camera ingests the pageful of text at a time, perform full textual analysis to place the recognized characters and words in the ‘virtual page’ in its memory for random access and communicates with the touch-pad device (3023) as well as the audio device (3021) if desired. The user uses the touch-pad peripheral device both for the presentation and the control purposes. Most of reading is done either via the tactile sensing of the dynamic Braille presentation or the audio narration (3021). The navigation from one part of the text to another may be achieved by ‘gestural’ maneuvers of fingers on the pad or via oral delivery of the control commands, for example.

The third type (303) describes the ‘pre-existing’ digital text. On computers and mobile phones or reading devices, the digitized text is loaded in memory of the device already, and the placement of the reading head is simply done by the user pointing to the part of the screen (3032) or using various gestural methods provided by such devices. The application of the invention is in the form of a simple auxiliary element that attaches to the side of such device (3031). The presence of the user's finger on the designated area of the element's surface initiates the main device to ‘stream’ its textual content via the dynamic Braille (501). The logistic control of the activity such as pausing, resuming, relocating the reading-head, etc may be done by a control mechanism provided by either the source device or the attached one. This functionality may also be used in parallel with the audio output that is prevalent in most such devices.

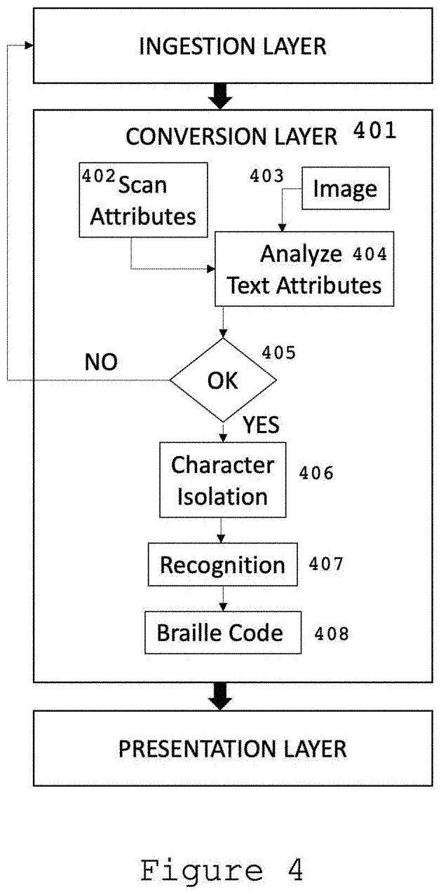

FIG. 4: This figure describes the logic flow of the conversion layer of the invention applicable to the text sources that requires the image-to-text conversion as part of its process. On the top, the ingestion layer delivers a frame of captured image (403 from methods described in 301 and 302) along with the metric information of the image acquisition (402). The metric information includes the mode of ingestion (camera? vs contact-scan?), scanning ‘speed’ (a relative quantity as measured in the unit of relative grid width vs. real-time), quality of operation (alignment of the scan direction and the lines of text, proper registry of the scan head and desired spot in the text, etc. These are conditional parameters that are critical in determining the quality of the reading experience and help provide feedback to the user (via simple beep or other cues from the device) in guiding the user to adjust his action. The resident logic unit analyzes the pattern in the given image (404) to infer vital statistics of the block of text that is being represented as an aggregate of black and white dots. The spatiotemporal correlatives of the distribution is used to decide whether capture is usable (405) first. If NO, it signals the user (a faint beep for example) and waits for the arrival of the subsequent batch of data from ingestion. If YES, the logic proceeds to crop the image to zoom-in on the designated sub-area of the image (‘detection window’) to isolate (406) the short train of characters and recognize (407) what they are. The size of the detection window is a variable that depends on the combination of several attributes of the text such as its line spacing, the inter-character spacing, font size as well as the font styles—seriffed, slanted, and on. Details pertinent to the invention are described in the Details section. Finally the recognized character(s) is ‘converted’ into the Braille or other prescribed symbolic code and passed on to the presentation layer so that the user ‘feels’ it.

If the ingestion mode uses the camera for a full page ingestion, the logic may use the prevalent optical character recognition (OCR) as the embedded code (or an adequate external service) to generate and store the pageful of text in memory. The presentation layer dictates how the content is delivered—automatic narrative mode or letter-by-letter streaming; by Braille or audio, etc)

Finally, the pre-existing digital text (303) allows bypassing most of the ingestion and conversion logic, but the same logistical elements of the invention apply to the presentation layer.

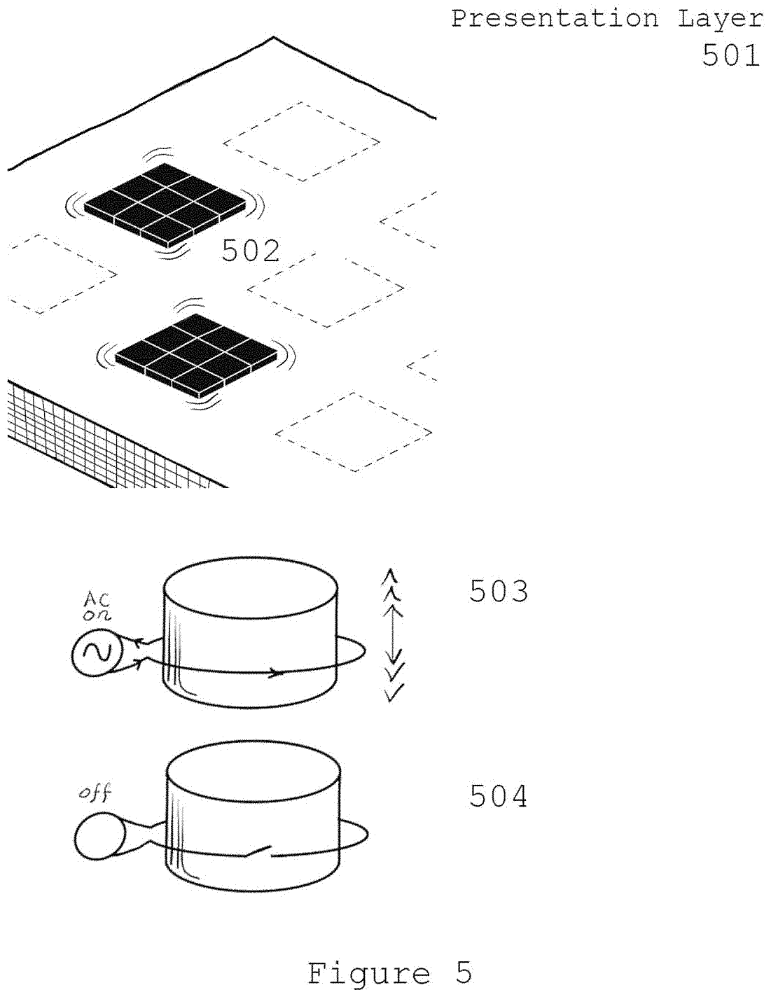

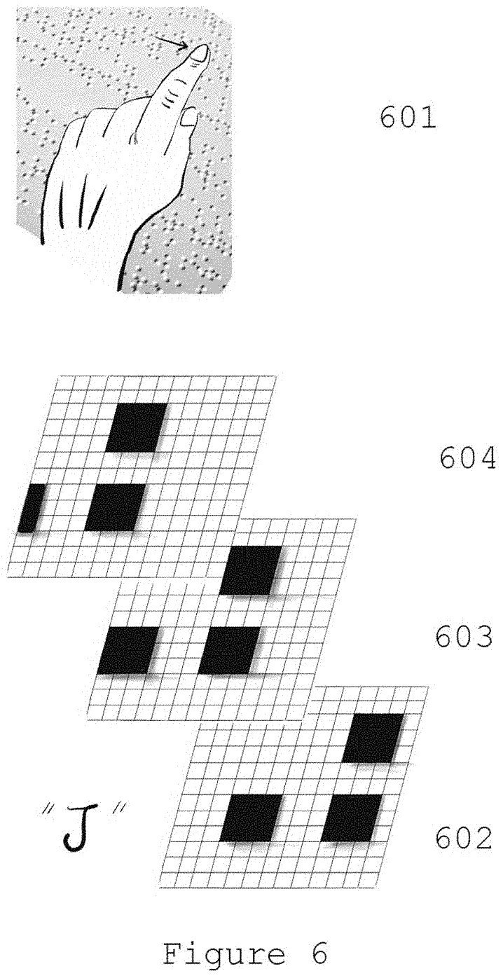

FIG. 5: The presentation layer of the invention describes ways to physically render the converted code in the tactile form (501). In its simplest form, (502) the layer comprises an M by N grid arrangement of pins with dynamically adjustable height, designed to replicate the typical Braille patterns. The figure shows a 3 by 3 arrangement where two of the elements (black) are in the active state (vibrating). The whole arranged set occupies an area comparable to that of a fingertip in the Braille-like rendition, or distributed in a larger area (in other body-worn renditions such as a patch on the back or a bracelet with large pins around its inner surface), on multiple body parts (rings worn on multiple fingers). Each pin may be driven between ON (embossed) and OFF states via deformation the inverse piezo effect or via mechanical vibration driven by the electromagnetic mechanics (503-504), localized injection of electrical current or ultrasonic jets. Material-wise, magnets, carbon nanotubes/meshes, deformable polymers are all possible candidates for realizing any of the above. The presentation layer is amenable to various renderings as long as they meet the set of essential requirements: 1) that the discrete states (ON/OFF or a dithered levels beyond the binary—FIG. 6 describes where such an application is beneficial.) of each constituent be dynamically controllable with responsiveness without hysteresis 2) the physical metrics of the rendered state be discernible, without pain and without ambiguity through tactile sense by a trained user 3) Robust for the touch-heavy use.

FIG. 6: The figure describes a detailed aspect of the tactile scanning of the Braille and its counterpart as realized in the presentation layer embodiment. Specifically, the finer-grained state representation that adds subtle motional cues in the tactile rendition of the Braille. The benefits include speed-reading and scan-correcting-feedback.

Consider the finger steadily scanning across the page of a book rendered in Braille. While each Braille letter is sufficiently represented as a set of dots, each of which may be embossed (ON) or not. The simplistic rendition as described in FIG. 5 envisions each dot, fixed in its location on the surface of the device, shifts between the ON and OFF states. This alone does not capture the whole of the sensation that the user feels as his finger moves across the line of text (601). The motional aspect of the pattern may play a significant role in imparting the contained information more accurately and swiftly, especially in the context equivalent to the ‘speed reading’.

This can be actualized if the presentation layer is embodied as a fine grained grid of dynamically deformable miniature elements. In this example (602), the arrangement is representing the Braille character ‘J’ in the form of three active (black squares) elements. Whether the embossment is rendered via physical deformation, vibration, electrical current or ultrasonic jet injection (FIG. 5), when each element is made of finer components (in 601-603, each is shown to comprise 3×3 subunits), the subunits are manipulated in a spatiotemporally coordinated manner to create a smooth animated motion of the pattern to the left as the sequence of frames 602, 603, 604 indicates.

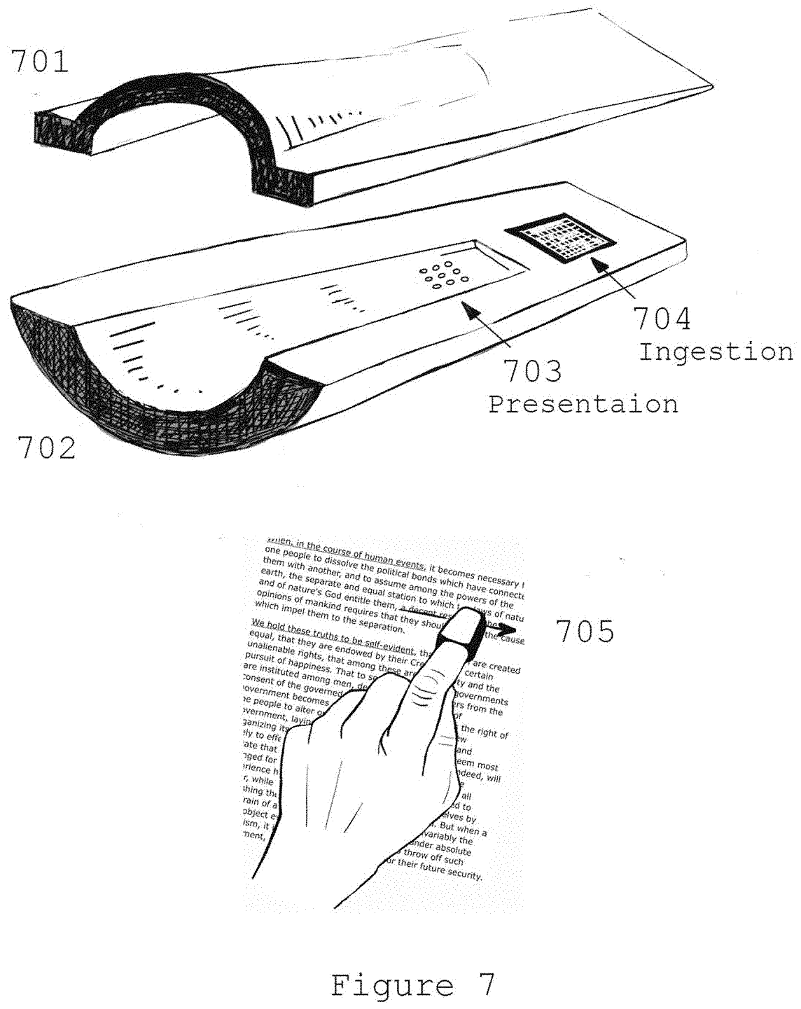

An additional benefit of having the presentation not only refreshable but also ‘movable’ with finer granularity is that it can be used as a subtle gestural feedback from the device to the user in guiding or correcting the ‘scanning’ action during reading sessions described in FIGS. 7-9.

This is also useful if the presentation layer is designed in a bar-like fashion as it allows displaying a long enough string of letters streaming by at any given moment. In this extended form factor combined with ‘animated’ rendition, the user may jump his own ‘reading head’ to revisit the part of the text for clarification, or even use two fingers on the bar if his training allows such an operation to his benefit.

FIG. 7: This figure describes the compact, self-contained mobile embodiment of the invention, loosely designated as the ‘thimble’ type contact scanning reader device. For illustration purpose, the device is rendered cut into upper cover (701) and lower part (702) that reveals a hole into which the user inserts his finger and let its bottom in contact with the presentation layer (703) which delivers the stream of dynamic Braille to be felt. The ingestion layer (704) comprises the contact scanner and illuminating element, and it may be placed directly under the presentation layer if compactness is the prime requirement, or as shown in the figure, may be located further forward in the device which allows its own size to accommodate larger scanning area. Not show, but the bottom of the presentation layer may also include a pressure-sensitive element for the user to gently press on to issue a useful action relevant for the logistics of the situation, such as switching mode (letter- or word-mode), presentation channel (from tactile to audio), or toggle to the ‘select-to-look-up-dictionary’ mode. The user uses the device on any text-bearing surface—printed or screen—and scans just as the visually impaired reader scans the traditional Braille book. The benefit of this particular embodiment is that any regular printed content can be casually read in the Braille in real time.

It also suggests further refinement of the embodiment logically follows that the common actions such as ‘copy-and-paste’, ‘copy-to-save’ or ‘copy-to-email’ be made available on his fingertip by adding an onboard communication unit to the device.

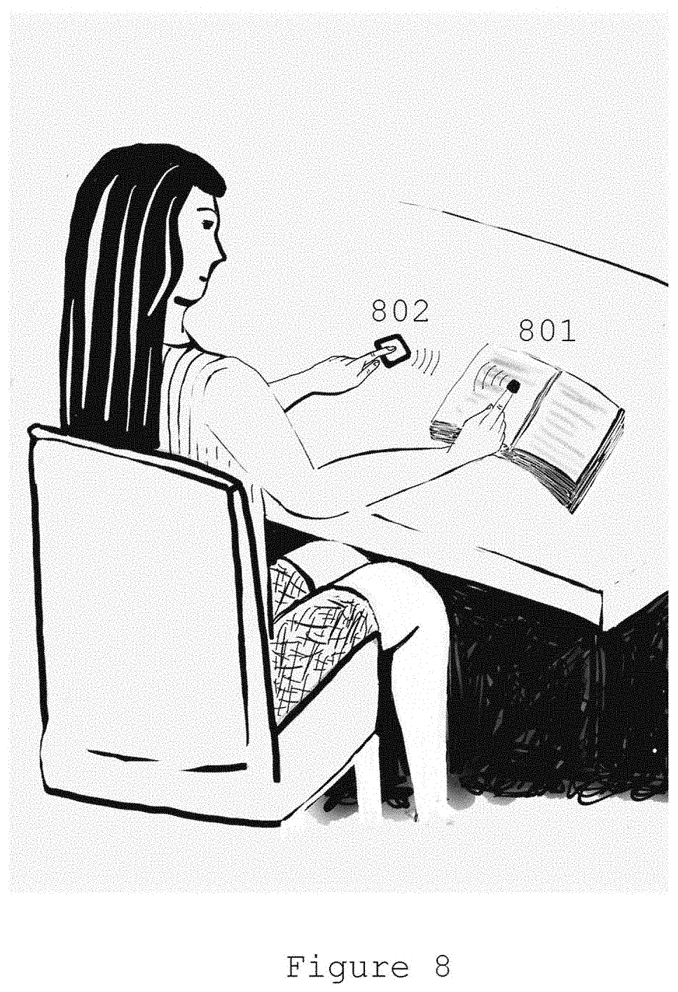

FIG. 8: The figure shows an embodiment of the invention that employs a modular form factor that separates the ingestion/conversion layer and the presentation layer. The communication between the modules may be wired or wireless. The bandwidth requirement is extremely small (a few bytes per sec) as the ingestion/conversion layer delivers only a few letter codes per second. In the figure the user ‘reads’ a page off an old book in the library by ingesting the string of letters (801) through the ingestion layer module worn on the index finger of her right hand, and decoding the corresponding Braille stream delivered to the mobile Braille presentation device (802). The motion of the right finger on the page is ‘replicated’ via the animated rendition of the flowing pattern on the pad as described in FIG. 6.

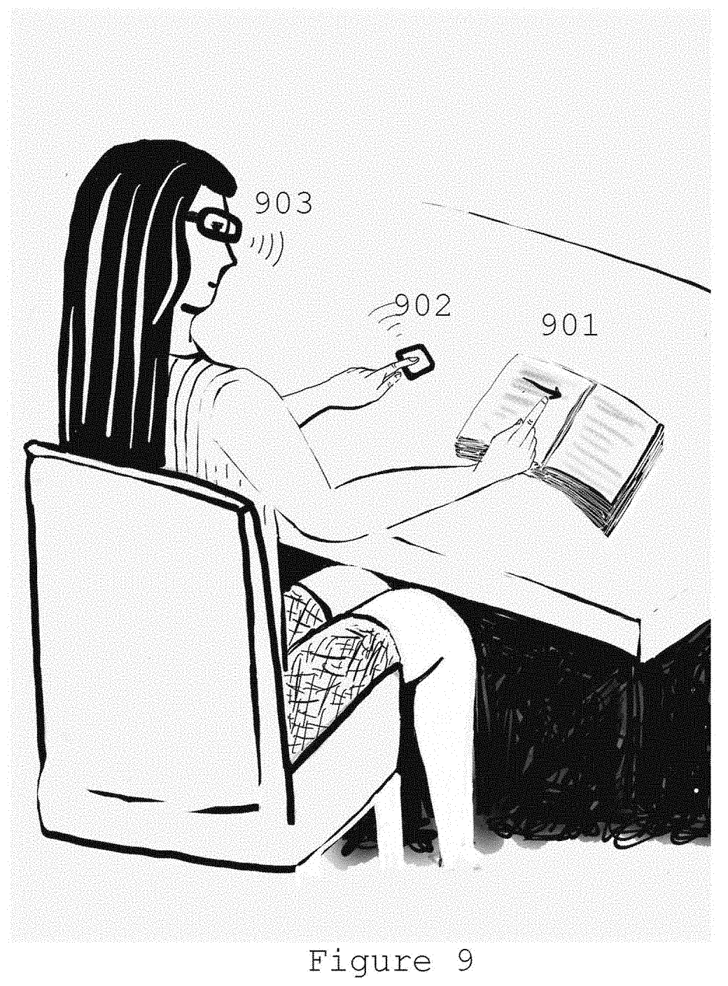

FIG. 9: The figure shows an embodiment of the invention that employs a camera mounted on the eyeglasses (903) as its primary ingestion layer for the visually impaired reader. The pageful of text may be ingested and converted, ready to be delivered piecemeal to the presentation device (902) under her left hand. The user uses the other hand mainly for navigating the ‘reading head’. The camera continuously tracks the fingertip position and extracts its corresponding position in the ‘reference’ text stream stored in its memory, and sends immediately the letter or word or the cluster of letters in its vicinity (depending on the preferred mode of presentation) to the presentation module. Ideally, the inter-device communication may use wireless methods, but may be also allowed tethered format in this application.

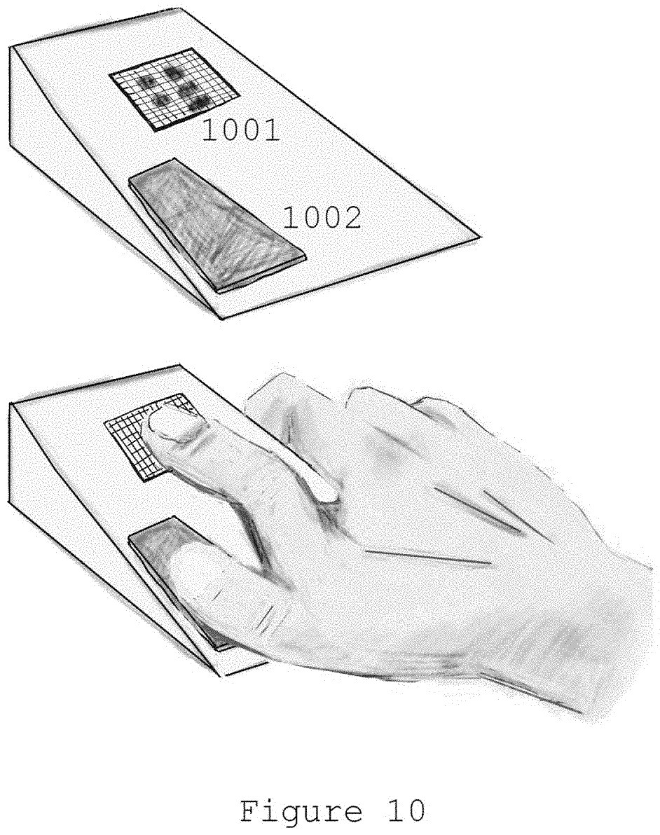

FIG. 10: The figure describes an embodiment of the invention, the presentation device in particular, in a design to accommodate the user feedback. In addition to the primary presentation layer as manifested in the dynamically refreshable Braille pad (1001), an area is also dedicated to receive the users gesture, a swipe or pressing of the thumb in this example. Elsewhere in the text, the invention describes that the Braille layer itself may be embodied to sense gestural movement of the finger touching it, if the cost tolerance is agreeable. The primary utility of such simple gestural feedback includes the navigation within the text source (e.g. next line), fine grain shifting of the reading head position, rewind/forward functions analogues to the voice recorder, invoking the dictionary lookup mode, etc. The invention also describes use of the simple lifting on and off the ingestion layer as the pause/resume command.

This embodiment form factor readily accommodates audio feedback elements (mic and speaker) as well as housing a more advanced logic processing module.

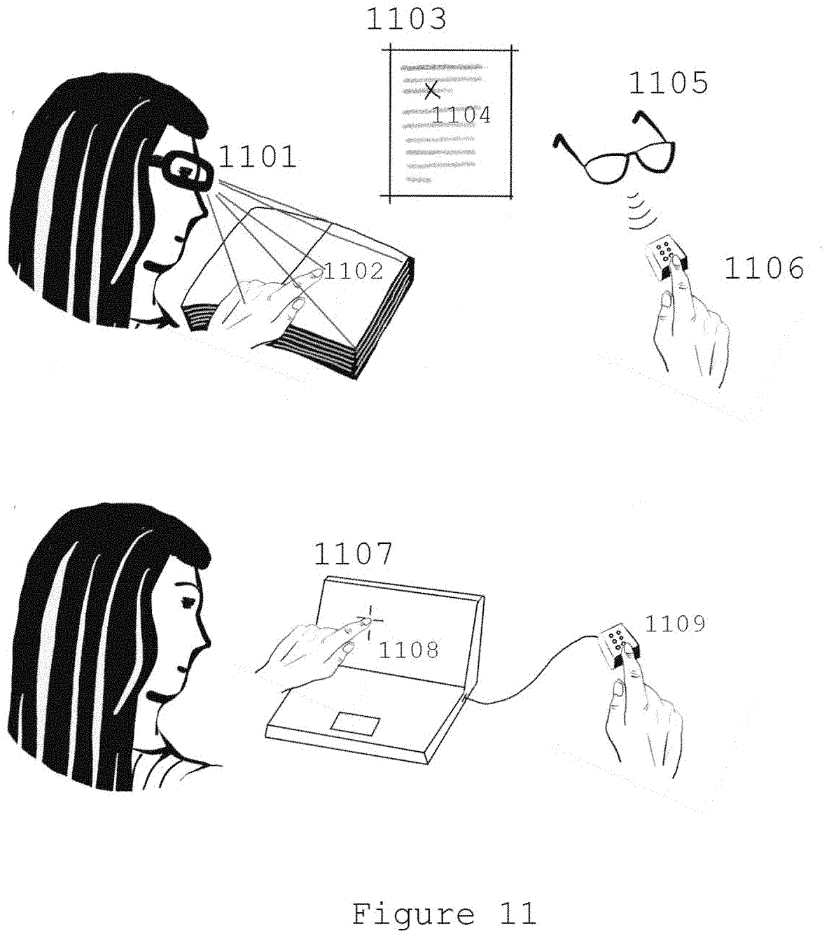

FIG. 11: The figure describes detailed logics of moving the reading head for two alternative ingestion modes. The top panel describes the use of a camera (1101) mounted on the frame of the eyeglasses to ingest the whole or a part of the page pointed at by the users finger. (1102) The process begins with a full page capture (1103) when the user turns a page. The whole image is analyzed and converted to digital text that is to be stored in memory of the conversion layer. The conversion layer is embedded as part of the ingestion device (1105). After this preliminary step, the device goes into the mode of continuous tracking of the finger as successive frames of captured image arrive. The location of the fingertip is mapped to the location in the digitized text stream, and that defines the current reading head. When the fingertip location is changed, the new batch of relevant text is transmitted to the presentation device. (1106) In one mode of presentation, such a reading-head simply initiates the automatic narrative process even after the fingertip is removed from view. The user may pause such a narrative process by using the prescribed gestural cue on his presentation device. The reading head is relocated when the user moves his fingertip to another part of the page. The narrative begins anew starting from the new head position.

In the second panel, the user is reading from the computer screen or a dedicated electronic book device. The screen is assumed to be touch sensitive so that the reading head moving maneuver described above applies here too. The main difference is that here the image analysis, character recognition, and internal mapping process are bypassed as the source is already in digital form, and the operating system is configured to derive the reading head position from the fingertip location on its screen.

Note that in both cases, it is also possible to use the presentation layer as a mouse pointing device, if it is worn on the finger or has the computer mouse-like form factor. In the mouse mode, the displacement is typically taken as the relative distance traversed from its previous location. Such non-absolute tracking of the traversal on the surface of the desk, when combined with the head-positioning operation using the direct touching of the screen/book described above, allows a quick scan forward or backward across the text away from the current reading head.

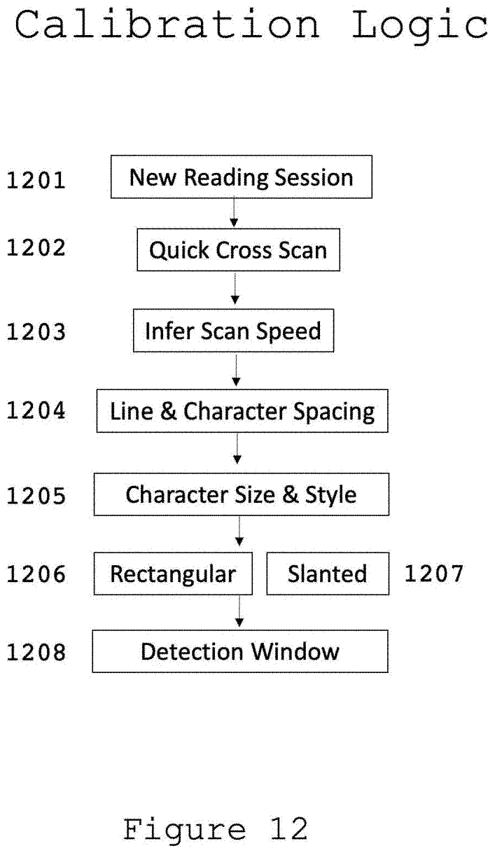

FIG. 12: The figure describes the initial calibration logic flow through which the user ‘trains’ the system to set up the virtual context in its memory to make the ‘seamless’ reading experience possible for the visually impaired. When one starts reading a book visually, there are several measures taken subconsciously: quick appraisal of the dimension of the page, size and distribution of the text, margins, orientation of the lines, inter-character spacing, font styles, etc. Such information assists the user in smoothly moving on the end of a line to the beginning of the next, adjusting his reading pace, and on. The visually impaired reader lacks much in this regard. To accurately locate the positions of each line in a book in Braille, a well trained reader should engage both hands: he would keep the index finger on one hand placed on the left edge of the text block marking the location of the line currently being read. As the reading head, i.e. index finger on his other hand, reaches the end of the line, then the left index finger moves down the line for the right one to correctly find the spot before resuming reading the new line.

The calibration described here as an example embodiment does the following: The new reading session starts upon the user's prompt (e.g. switching on the device 1201) and the device starts in the calibration mode. The quick edge-to-edge scans are performed in both vertical and horizontal directions. (1202) Analyzing the spatiotemporal distribution of the inky spots in the data stream obtained in the scans, the width and height of the page and of the text block, inter-line and inter-character spacing are obtained. (1204) The scan speed is also inferred using the internal clock and the sensor grid specs. (1203) Further analysis of the distribution pattern yields the typical letter size in the page. From the orientational correlates of lines in the text, one can further discern the more problematic presence of slanted (italicized) text style (1205-1207).

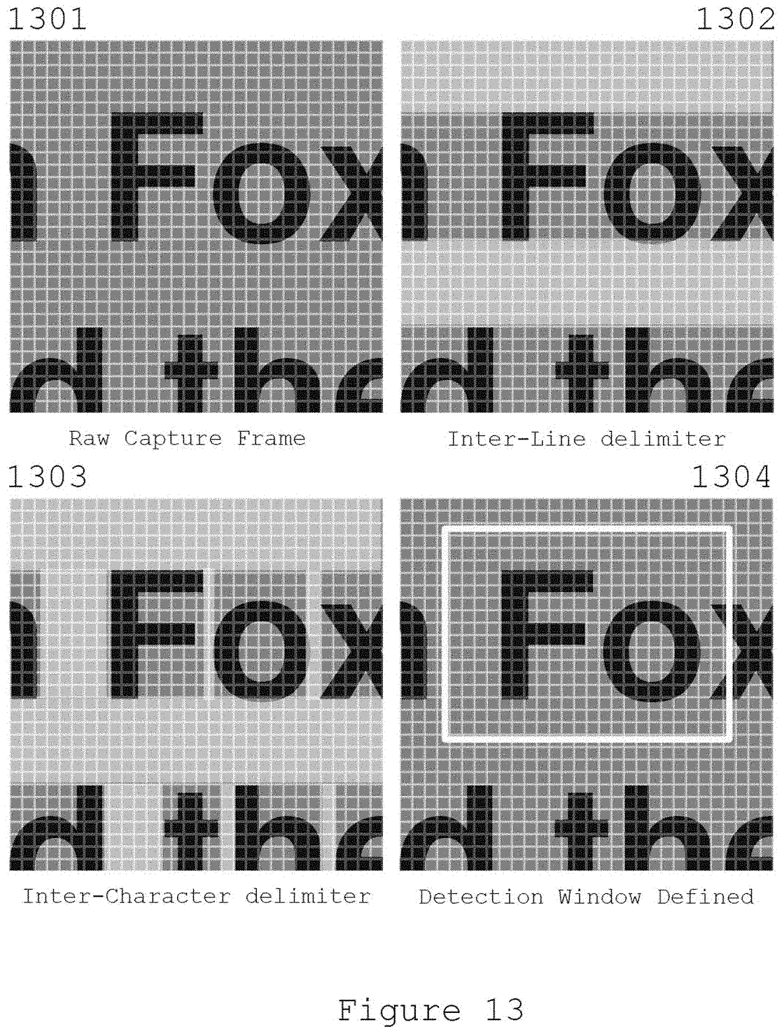

In the simple embodiment of the contact scanning layer, the size of the grid is limited to a few lines high and a word or two wide. This is adequate in reading text populated with the same letter size as the most commonly used, but limiting if the text characteristic becomes more complex. So, whenever feasible, the embodiment of the ingestion layer would push the envelope toward a larger scanning area. Keeping this in mind, the logic would dynamically identify the sub-area within the whole ingestion grid that contains only a few letters that suffice to be converted and presented at any given moment. The size of the ‘detection window’ (1208) of rectangular shape is dynamically adjusted from the attributes determined from the quick cross scan. If the text contains slanted letters, the window is slanted and applied before it is used to mask out the desired area of analysis. (more details of the logistics described in FIG. 13)

Many of these steps may be bypassed if a comprehensive machine-intelligence image-to-text conversion is accessible with adequate throughput and energy efficiency. The invention is amenable to incorporating any such conversion logic at the implementor's discretion as long as the almost instant responsiveness of the ingestion-conversion-presentation flow is not compromised.

FIG. 13: This figure describes the aspects of the text block in a page that are useful in identifying the ‘detection window’, the sub-area of the contact scanning layer, that contains the appropriate amount of characters to focus on. They are derived from analyzing the autocorrelation function of the ingested frame image. The first panel shows the raw image as ingested from the print page (1301) The ‘inter-line delimiter’ are identifiable as contiguous horizontal strips of white pixels (1302) while the ‘inter-character delimiters’ are vertical strips as identified between neighboring characters (1303). Identifying the width of these delimiters, the ingestion logic derives the rough estimate of the character size. (in a typical print material, such an analysis may be done once for each page or even for the volume and the calibration logics was outlined in FIG. 12. Otherwise, the calibration may be performed more frequently as the ingestion progresses over more complex text.) Once the character size is estimated, the detection window is determined as a sub-rectangle within the bounds of the original image. (1304) Here, the detection window is big enough to contain 2 or 3 characters, and is placed in the upper side. As long as the user's scanning movement stays within the range to maintain the cushion of upper and lower inter-line delimiters with continuity, the conversion process may continue using what is inside the window. Otherwise, the system will alert and guide the user to recover the correct scanning trajectory. In this frame, the outcome of the conversion process yields ‘F’ and ‘o’ as identified characters.

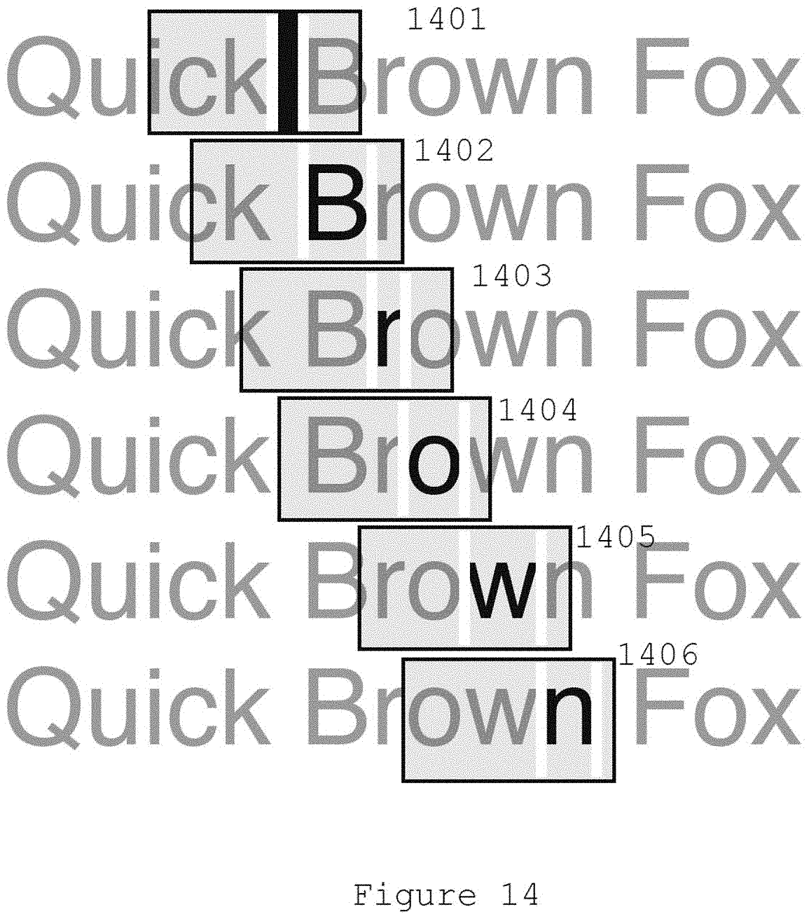

FIG. 14: This figure illustrates the heuristics the contact scan methods may use in ingesting and identifying the stream of characters as the detection window (1304) of the ingestion layer's grid sweeps across the line of text. The six representative snapshots are shown, beginning with the top panel at the earliest time in the sequence. (1401) The heuristic rule chosen as the selection criteria is the following: Consider only the characters and punctuation marks (including inter-word gap) identified that are also bracketed at both ends by the inter-character delimiters within the window. Out of those, if any, only the last item is selected for the frame. Based on this rule, the inter-word gap is chosen for the initial frame (black bar in 1401), ‘B’ is selected for the next (1402: ‘r’ has not yet fully entered the window as its delimiter on the right side is missing.) followed by ‘r’ and on. Eventually, the sequence (1401-1406) identifies and presents the letters in the word “Brown”. Within each bracket, the character or the punctuation marks are identified using a set of heuristic rules or neural-net based character recognition logics. The logic may further improve accuracy of ongoing character recognition by managing a cache of the few preceding characters since the last identified inter-word gap, and looking for matches with part of a valid word(s) in the lookup dictionary. In the example above, the cache would contain “Brow” by the time 1405 is processed, and therefore the next step proceeds with high level confidence of encountering ‘n’ next.

An embodiment that is useful to illustrate how the invention works is an idealized standalone device described as Thimble earlier. (Thimble is a metal or plastic cap with a closed end, worn to protect the finger and push the needle in sewing.) This device integrates all three layers—text ingestion, conversion and presentation—and as its name suggests is envisioned to be worn on the tip of the user's finger.

While it is ideal if the whole functionality of such a device can be compact enough to fit within the area of a fingertip, the presentation layer should satisfy the physiological reality of the user. In other words, the lateral dimension of the presentation layer may be of different size than that of the ingestion layer. While the latter suffices to scan in a few characters at a time with resolution that satisfies the requirement of the character recognition logic, the former needs to meet the spatiotemporal sensitivity that is dictated by the neurology of the body part.

For the sake of illustration below, we use its ideal embodiment that is good enough to replicate the functionality of the traditional Braille on the tip of the user's finger, although the presentation layer may be of significantly larger in size or may even be distributed over multiple body parts, such as all fingers on a hand.

As the user lays his finger wearing the device on a printed page (of a book, newspaper or any printed material) with its ingestion sensor layer facing (and touching) the print surface and moves across a line of text, the text-ingestion layer scans the characters and passes them to the conversion logic layer. The conversion layer decodes each character and converts it into the prescribed code pattern and passes it down to the presentation layer. A surface of the presentation layer is in direct contact with the skin of the user's finger (or other suitably chosen body part), and actuates the code pattern e.g. Braille. This constitutes the unit operation for the character as the actuated pattern persists until the next character (or a blank space/delimiter) comes into the center of the sensor matrix of the ingestion layer device. As the user moves the finger across the block of text, the device repeats the same process, delivering the succession of Braille codes that matches the line of the text thus traversed. The reading speed is controlled by how fast the user moves his finger and is limited by the user's ability to detect and accurately decode each code. This reproduces the experience of reading a book rendered in Braille but makes all existing print books instantly available for the visually impaired.

The text ingestion layer may be actualized in the following way: Typically printed text material uses ink on paper. The layer of the ingestion device in direct contact with the printed material is designed as a matrix of miniature electric sensors that are sensitive to the varying contact potential. Each node of the sensor matrix then detects the contrast in the electrical conductance as the inked zone conducts while the pristine paper does not.

There are alternative ways to achieve the same result: for example, direct imaging of the area using a miniature pin-hole camera followed by a dithering image process may yield an N by N, black (1) and white (0) digital rendition of an alphabet character or part of it, if present, in its central field of view.

A frame in the form of such N by N black and white rendition is passed to the processing layer. As the user's finger traverses a line of text, a time series of such images captured at regular intervals is obtained and ener the ‘conversion’ logic layer to be analyzed. Each image is processed to recognize the central character symbol or a delimiter such as the ‘space’ or the end-of-the-line.

Each sensor element in the matrix produces a time series data of on and off. These signals are naturally correlated both spatially and temporally, reflecting the underlying shape of each individual character, the overall movement of the matrix. These autocorrelation properties are used to clean up the noises due to irregularities in source and motion, and remove ambiguity.

Blank space between characters in the text provides the natural delimiter between characters from others, Period symbol followed by space, the end of a sentence. Sensors on either the top or the bottom row of the matrix are used to guide the user in consistently moving the matrix along the direction of the line of text. When the movement strays from the proper alignment, the device indicates the deviation via appropriate feedback, either on the touch-display layer or via audio feedback, in a manner modern automobiles alert the driver when he deviates from the lanes. Previously read characters may be stored temporarily in the cache memory of the processing logic to further check and guidance for consistency.

The following explains ways to further insure the quality of the character isolation: The overall dimension of the sensor grid is to be big enough for its vertical span to cover more than a single line of text. That way, the rows of sensors in upper and lower parts of the grid register null signals consistently so that the processing logic may isolate the line of interest. As the finger moves so that a specific character comes into its central zone, the sensor elements along the leading edge of the grid first register its entry into the grid. After the grid moves further down the text line so that the said character moves out of the grid bounds, the dots on the trailing edge of the sensor matrix register its exit as signals on them go to null coherently. The signals captured during this interval by the dots constitute the basic material from which the decoding process extracts the stable character image in the zone. A complication may arise if the characters are too densely populated, if some part of the character is missing, etc. These are to be dealt with more sophisticated analytics of the signals and by enlarging the size of the matrix so that the logic switches the granularity of the recognition from character to word.

For every usable character thus obtained, the conversion layer applies a neural net-based character recognition logic (i.e. OCR) or other appropriate image-to-text conversion methods. Successfully decoded characters are then passed on to the presentation layer.

For each character passed on from the decoding layer, the processor logic generates the binary code in a prescribed manner (e.g. 6- or 8-pin Braille) and actuates it on the surface of the presentation layer that is in direct contact with the user's skin (of the finger).

As an illustration, consider the user uses his index finger as the receptor of the train of Braille codes. The human finger-tip skin has a dense matrix of tactile receptors of both slow- and fast-adapting kinds that can perceive forces as small as 10 mN (tactile pressure sensitivity) and displacement of 10 um. A computer keyboard uses the force ranging in 0.04-0.25 newton for its tactile feedback. Typical spatial resolution (point localization) of the fingertip is of sub-mm. Collectively these receptors sense vibrations in the range of 0.5 Hz to 700 Hz. (Most sensitive for the 200-300 Hz range) Temporal resolution is about 5 ms.

Thus, the invention describes such an embodiment of the presentation mechanics as follows: The layer is to be an M by N matrix of capacitive dots embedded in an insulating substrate. M may be 4 and N, 2 if a set of 2\hat{ }8 distinct characters/symbols suffice, for example. (The traditional Braille uses 3×2 matrix of embossed dots, barely adequate for the Alphabet characters. To include more symbols, 4×2 or even 4×4 grid may be considered. To further accommodate special feedback indicators, a separate row may be added with clear separation from the primary Braille block.)

The presentation layer's logic includes the control logic that dynamically turns on and off (through the charge/discharge cycles of each capacitive element of the matrix) so that the matrix pattern thus actuated represents the character over which the user's finger is hovering at the given moment. The electrostatic pattern transmuted to a set of localized tactile sensation such as simulated vibration or pinprick sensation through the current injection is then perceived by the user and further processed in his brain just like the traditional Braille bypass the visual blockage in communicating a character to the brain.

The presentation layer of the invention may be embodied utilizing other types of physical mechanisms as long as the method induces the refreshable sensations reliably and fast to be perceived by the trained user at his desired ‘reading’ speed.

One such alternative rendition of the dynamic Braille is through inducing morphological change of the pliable surface resulting in the simulated ‘writing’ and ‘erasure’ embossment cycles of characters scrolling by. The local deformation may be designed to be induced and controlled by the so-called inverse piezoelectric effect whereby a material goes through reversible deformation when subject to an appropriately polarized electric field.

Another method may be driven by electromagnetic manipulation of magnetized pins. The Braille pattern may be momentarily manifested by selectively driving pins to vibrate vertically (1) or remain static (0), whose haptic pattern is then sensed by the user's body part.

The user intent and other factors such as the manufacturing cost, energy efficiency, actuation speed, and reliability are among the constraints that would favor one style of embodiment over another. While the purely electronic actuation (current injection or simulated local vibration) method is relatively advantageous in allowing swift response, it could be affected by the moisture level on the user's skin and individual variations in the tactile sensitivity.

The ‘thimble’-style device is an idealized embodiment of the invention in that it is compact, portable and allows practically instantaneous access to a wide variety of text bearing media for the visually impaired. The invention extends beyond this particular format as multiple alternative ways exist for both the ingestion and the presentation layers and their combinatorial possibilities are numerous.

One such combinatorial variation in the embodiment of the invention goes as follows: the text is ingested via the video camera mounted on the user's head (head-band) or as part of the eyeglasses. The image of the ambient scene or a pageful of a book open in front of the user is scanned into the device memory when the user issues the prescribed gesture command. Or the control logic may automatically extract stable image representation of the text elements using a computer vision analysis of the continuous stream of captured image frames. The result may be multiple instances of textual blocks, such as ‘exit’ and signs of street names, taking positions in the projected two-dimensional projection of the scene within the camera's field of view.

Depending on whether the usage context is (A) for reading the page in a book or (B) for navigating in the street, the presentation layer may opt for a different mode of presentation. In (A), the ingested image is fed to the conversion layer for an OCR operation that could be performed onboard the ingestion layer or run on a mobile phone or other portable devices. The output of the conversion process follows essentially the same workflow as what happens in the ‘thimble’ book reader. In contrast to the use of fingertip itself as the navigation pointer with the ‘thimble’ device, the user shifts the area of focus using body gestures or other dedicated feedback parts in this case.

In the case (B) of navigating the street, the density of the relevant text is light but contingent on the user's location and orientation in the environment. Having the projected locations of the recognized text blocks with respect to the user's (or the camera's) orientation, when the user ‘enters’ the reading mode, the presentation lay may track user's head movement to determine which text block to ‘present’ at a given moment, and transmit the corresponding stream of words through tactile stimuli. The sensing of these stimuli may occur on the user's fingertip if he is wearing a glove-like device, or on the torso or on the back of the user's body if he is wearing a patch-like embodiment. In the latter, the code may be a simple Morse code as the skin on that part of the body may lack the spatial resolution to warrant the use of Braille form.

The invention describes alternative ways to present the code using the actuator configuration besides employing the traditional Braille-like representation sensed by the fingertip or small body part(s). These include, not exclusively, embodiments of the invention as a set of rings or bracelets worn on multiple fingers, wrists, necks, or ankles of the user. As a peripheral sensory device attached to a computer or other desktop machine, the ubiquitous touchpad form is desirable that renders the dynamic Braille patterns on the user's palm or across multiple fingers, and also affords extra space for touch-gestures for operational controls.

Individual component (also designated as ‘pin’ or ‘dot’) of the given embodiment represents the discrete state variable (“I/O” or “On/Off”) that corresponds to the embossed state of each element in a Braille letter. The invention describes that the physical rendition of the state may be in the form of a burst of vibration, a sophisticated spatiotemporal pattern of electric current injected to generate various tactile sensations, a gentle cycle of contraction/release—e.g. bracelet, or a electrically induced deformation of distributed elements that generates the sensation of touching a set of embossed pins passing by under user's skin.

The actual physical mechanism to produce the state differential may differ among various embodiments of the invention. The vibration for each ‘dot’ may be generated by a miniature magnet embedded in a ‘coil’ carrying an AC current. (503-504) Shunting on and off the current will turn the element on or off.

The illusion of the embossed ‘pins’ travelling by under the user's contact point is produced by embodiment of each ‘pin’ element (as perceived as an embossed dot in a Braille letter) that comprises sub-elements, if the presentation layer's design so allows, each activating/deactivating in the spatiotemporally coordinated manner, just as the pixels on the TV set creates the visual sensation of smooth motion. (502) Such an effect may also be generated in the analog manner if the embodiment uses elements that are controlled by inverse piezoelectric effect, electroactive polymers or carbon nanomeshes, etc, as long as the hysteresis is compatible with the pace of the refresh cycles of the letters, i.e. reading speed.

It is assumed that the prospective user is willingly subject to the prescribed training designed specifically for his chosen type of embodiment.

With the conversion layer equipped with word recognition capability from the incoming stream of individual recognized characters, an embodiment of the presentation layer is described that delivers such string of words through synthesized phonetic pronunciation via a set of earphones or equivalent devices. When the user moves the finger rapidly forward, this produces the audio stream that sounds like a recorded tape being fast-forwarded. The same method is applicable to browsing a musical score.

The embodiment of the invention as an auxiliary input and output device attached to a powerful logic processing capability such as computer or mobile devices benefits from unlimited power reservoir, audio synthesizing, word recognition, grammar correction, extra control over navigation and secondary functions, use of gestures and other types of feedback, etc. Such an embodiment may be packaged in a mouse- or touch-pad like form factor.

The ‘thimble’ style embodiment of the presentation layer coordinates closely with the movement and location of the ingestion layer as its anchor point shifts from a character to the next one. The tight integration of the ingestion, the conversion, and the presentation layers into a compact wearable form factor is ideal for casual ‘reading’ of any printed medium. The objective is simple for the device: read the single character at a time and convert it to corresponding symbol and render on the fly. The active involvement of the user's finger as part of the process eliminates ambiguity as its intuitive maneuvers—positioning, stopping and moving, etc—frees the machine logic from having to second guess the user's intention. On the user's part, the ‘reading’ or ‘browsing’ experience is subtly yet significantly enhanced for immediacy and lack of inaccuracies.

On the other hand, the embodiment using a video-camera to ingest the bulk (a page or a paragraph of text) or a computing device with preloaded digital text (the whole stack of books or typical web browsing) is free of the requirement to keep a close registry between the ingestion and the presentation paces.

In this case, the user's finger stays at rest most of the time except on occasions when he uses it as a pointer to move the reading ‘head’ in the bulk of the text in the device memory. With this, the display logic automatically scrolls the text by presenting one character at a time on the tactile presentation layer. The user experiences it as if a Braille ticker tape is scrolling by under his fingertip at the prescribed speed controllable at his convenience. When the user taps on another part of the page, be it a printed one being monitored by the camera or a webpage on the computer screen, the device pauses and then relocates its reading-head on the new position to resume the passive ‘reading’ process. The device may also incorporate the existing presentation technique of voice narrating the words or sentences.

It is obvious that an embodiment that combines both the ‘thimble’—style and the ‘BrailleOver’-style methods is feasible with the former worn on a finger, the other worn as the pair of an Augmented Reality (AR) capable eyeglasses.

The invention also describes several alternative embodiments in which the user's finger is tracked to interpret his navigational intent or to invoke various tasks as part of the reading/browsing activity even without the benefit of the pre-digitized bulk text such as described for the BrailleOver above. In one embodiment a touch-sensitive area of rectangular or a strip form is placed in the vicinity of the main display actuation area. The entire area of the ‘pointing pad’ is mapped to the body of text, be it already ingested and in device memory or just a placeholder for the mapping purpose. Using his other available hand, the user interacts with the pad to randomly access the different parts of the text. This is to provide what the normal reader of a book instantaneously shifts his visual focus from one area of text to the other when skimming a book. When the body of the available text is more than a pageful, such a navigational control replicates the page-turns and other navigational maneuvers that are trivial for visually intact readers yet cumbersome and slow for the impaired.

In embodiments of various forms including the integrated ‘thimble’ or more modular renditions of the ingestion- and the presentation-layers as separate entities, the presentation layer, the invention describes ways to accommodate the user feedback. A subtle pressure exerted on the contact point between the ingestion layer and the surface of the print medium propagates the timestamped event along with the ingested text source data. The presentation layer may interpret such user-initiated events in various ways—either prescribed or contingent on the context at the moment. Just to give an example, the processing logic of the embodiment may use such cue to look up the dictionary for the word that had been ‘read’ in at the time, and switch momentarily the presentation context to the ‘display’ its meaning as long as the user halts the pointer movement, the fingertip.

In another example, the ‘tap’ on an empty area of the page may bring up the list of navigational options and set it as the virtual context in which further ‘reading’ and ‘gesture’ are done until the user issues the canceling gesture (e.g. another tap) to get out of said virtual context back to the ‘reading’ mode on the print page.

Another gesture may be used to select it to be replaced by another word which is voiced or touch-typed (on a separate keyboard) by the user to give an example of an example beyond passive reading.

In FIGS. 13-14, a possible logic for the ingestion operation of a character is described in detail for the embodiment of the mobile contact scanner. Note that while the character-by-character ingestion in such a mobile, direct contact-scan mode offers benefits of immediately responsive control of the ‘reading’ experience and reduced computational burden for the mobile form factor, it poses some hurdles for it to be practical and yield consistent reading.

Consider, for example, an N by N grid of miniature optical sensors, each detecting either 1 (black ink) or 0 (white) states of the point under it as the whole unit moves across the printed material at a steady speed. Taking the size of the grid to match the surface area of the index fingertip of an adult, and requiring the size of each sensor element to yield resolution good enough for digitally representing a printed character in a book, N˜30 with each sensor takes up a square area 1/72th of an inch in each direction.

Then, there are a couple of characters (in a row or two of text lines) within the moving window of scanning at any given moment. As the first step, the logic unit determines the proper scale for the sub-area of the scan area that is fit for an isolated character of the given text source. In doing so, it uses among others the character boundary indicators (delimiters) identifiable as the coherent rows and columns of 0's enclosing each character.

In starting to read a book, the device may prompt the user for a quick ‘survey’ scan down the row of text in the source to analyze the spatial patterns of the delimiters that crisscross the area.

Once the height of the single row of text is roughly determined, the number of sensors to cover the vertical say of a character, M, is inferred. A strip sub-matrix of dimension M×N embedded within the original N×N grid of the sensor area of the device is then designated the ‘detection window. The logic unit continuously monitors the two-dimensional pattern of ones and zeros that pass through this detection window.

Over the fraction of a second during which the detection window moves across the zone of the page that is occupied by the letter “f”, for example, multiple readings of the matrix pattern are made. As the window moves across, that particular letter first enters the field of view from the left edge of the window, passes its center, then exits through the right edge.

Each of such passing characters is bracketed by delimiting indicators identified by the coherent vertical columns of zeros on either side of it. Depending on the relative sizes of the detection window and the typical character, one, two or even more such delimiters may be present and detected within the window at any given moment. The logic will focus on the small area that is between two rightmost delimiters and submit it for the character recognition operation. The sole operational objective of the conversion layer is to decode the character on the leading edge of the train of characters within that detection window at any given moment.

For example, as the sensor matrix moves from the zone of “A” to “f”, the sensors on the leading edge of the matrix register “0” for a few consecutive readings before the right edge of the matrix first enters the zone of “f”. When the reading head moves further along “f” moves further to the left with another delimiter of “0”s on its right side. For a brief duration, “f” is then occupying the focus of the ingestion as it is bracketed by these delimiters on the right-most sub-zone in the detection window.

To resolve possible confusion arising from repetitive characters (such as the ‘a’ character in the word ‘aardvark’), the processing control may use the lateral position of the rightmost delimiter column within the detection window by monitoring its periodic variation that naturally occurs as each character enters and exits the area. In addition to this, the system has access to the speed of the movement of the reading head which, combined with the duration of a specific character that persists un-delimited in the queue of the character stream, allows its processing logic to detect redundancy. While the heuristic logic may suffice for operating the compact and portable embodiment of the invention as a reading device, modular configurations allow external computing elements (that may also take the role of the main conversion layer) to provide better correction mechanism: for example, as do the spell- and grammar-checkers work in most modern word processors with their word-completion logics.

The invention describes the conversion layer logic is configurable with the character and word recognition logic to accommodate the user's reading style and speed requirement as they vary with the nature of each reading session. The upper bound of the reading speed on the traditional Braille by a well-trained reader can be found in various videos posted online: (http://youtube.com and search for “Learn Braille In One Lesson” for an example). The user's desired reading speed sets the rate at which the tactile display should refresh. There are factors to consider designing an embodiment of the presentation layer: for example, the hysteresis that limits the agility of an electric, electro-magneto, or mechanical-actuation mechanism that affect the refresh rate. The logic processing speed in the ingestion and the conversion layers—i.e. the source—may be the limiting factor too.

The compliance resolution for detecting deformation, which is about ˜20% for the tactile sensor, is also considered in the design of the embodiment of the presentation layer. This limits how rapidly an expert Braille reader may move his finger across the line and decode with accuracy.

When the user moves the reading head from the end of line 10, for example, to the beginning of line 11, how does the system ensure the new position lands reasonably well on the right spot? If he fails, how does the device deal with it? In traditional Braille reading, this problem is solved by using both hands: When the reading by the right index finger starts on a new line, the left index finger moves from its current position at its left edge down to that of the next line (line 11) to keep itself as an anchor. As the right index finger reaches the end of the line 10, it can move itself to where the left finger is anchored to continue reading. At the same time, the left finger moves one line down and the cycle repeats.

The invention describes a method that provides the equivalent functionality in the use of its embodiment, the contact-scan-ingestion with a limited scan area in particular (e.g. ‘Thimble’ type) but without committing both hands.

First, a simple calibration step is performed at the start of reading the new page. The user scans the page vertically down on the left-side edge of the text. This creates an internal reference model that contains the first few characters of each line. The process of creating the internal reference image out of the small scanned images stitched borrows the well established way the panorama photos are created out of multiple images on modern day cameras. When the reading head reaches the end of the current line, the user moves the reading head down the line and to its left-side edge. The image newly acquired on the landing spot is then compared and located in the ‘reference’ image, and checked whether it is reasonably adjacent to where it should be for the next line. When it is not, the device gives feedback (via audio or tactile cues) to guide him make adjustments to the position. Once the user successfully maneuvers the head into good position, the device proceeds with the reading process.

Multi-sensory Environmental Scanner for assisting the visually impaired and other operational or recreational uses (“Synesthetic Sensory Converter”)

The invention discloses an algorithmic device for capturing and processing of environmental cues in real-time and placing the user in the trans-sensory landscape by delivering a textured cluster of their synthetic representation, prioritized, filtered, and adapted for the alternate accessible sensory channel.

The device provides the sensor-deprived user with a way to make decisions and take actions quickly without having to depend solely on the decision and potentially inadequate recommendations made by the machine-intelligence.

The device ingests environmental sensory data, extracts sensory cues, transmutes and delivers them through the alternate sensory channel(s) without excessive prejudice on how to interpret them. The transformation of the sensory landscape of one type (visual, for example) into one of another (aural) is in effect synthesized manifestation of an aspect of synesthesia phenomenon that is naturally found in the population.

The beneficiary of the invention, with adequate training on utilizing the alternate perception-pathway, is then guided by his own intelligence that is fully alert on interpreting the complex and dynamical environment.

At the same time, the invention describes the way ‘machine intelligence’ is incorporated in a controlled way so that its beneficiary maintains access to both his own and the machine intelligence work asynchronously to complement each other.

The invention advocates the approach that allows more of the sensory cues to reach and enter the user's cognitive pathway so that his own analytical and intuitive intelligence have access to process them, while at the same time the full arsenal of machine intelligence work on them in parallel, and exchange feedback asynchronously to minimize any blockage and interferences in the cognition-analytics-decision-action-feedback cycle. In this sense, the cognitive pathway bifurcates into two complementary branches.

But to what extent and in what ways such lower-level sensory data benefit the user? There are individuals with sensory deprivation who overcame their handicap to achieve extraordinary levels of competence in the art of trans-sensory perception. Musicians with hearing loss are known to train themselves to use the tactile sensor to ‘feel’ the music through vibrations it induces. Evelyn Glennie, the Grammy award winning percussionist has claimed that despite being deaf, she senses the music through vibration that allows her to play not only solo but make music with others and compose. It is also common knowledge that a form of echolocation technique (Bats use ultrasound in navigation) is used by many blind people for navigation. Daniel Kish, the well known practitioner of the human echolocation, and the president of World Access for the Blind, rides a bike on the street.

[https://www.youtube.com/watch?v=uH0aihGWB8U and https://www.youtube.com/watch?v=-kB1-P-hZzq]

The invention draws inspiration from such cases and provides a nuanced solution by stepping back from the machine-intelligence centric approach. Instead, it engages the user's own intelligence—its intuition and analytic skills—early on in the cognitive pathway where the complex and evolving sensory landscape are digested and vital patterns recognized at any given moment. The invention facilitates this by building a trans-sensory landscape and immersing the user in it through his functional alternate sensory channel. It would be amiss if the invention neglects to take advantage of ever improving machine intelligence (MI), machine learning (ML) in particular. In addition to being the vital component of the trans-sensory landscape building, MI/ML forms the other strand of the braid that provides high-level information on objects in the landscape with depth and breadth beyond human capacity in a non-intrusive manner.

The user controls the balance between the two strands of the braid, bringing the invention closer to faithfully presenting the multi-tiered context that mirrors a typical real-life scene with all its dynamism and complexity. The beneficiary, sufficiently trained in the art of ‘reading’ the trans-sensory landscape, can make quick and pertinent decisions by pulling both resources, the human and the machine intelligence, in the way on par with the unafflicted.

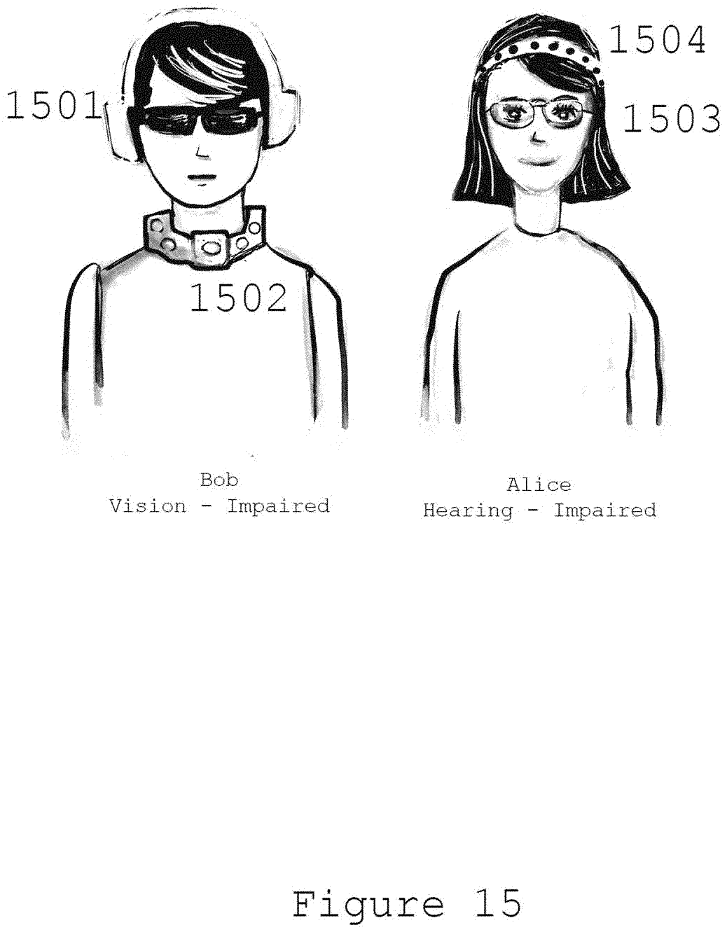

FIG. 15: Two main beneficiaries are shown. Bob is a severely vision-impaired person. He is shown wearing the embodiment of the invention that is configured to operate to assist him to navigate outdoors. His Prime Raw Sensor is auditory, so as the primary method of receiving environmental cues, he uses the set of headphones. (1501) He is also shown wearing a neckband (1502) to receive the Tactile cues generated by the invention. It is composed of multiple units of tactile stimulus generating elements (either through vibration or pressure) dotted around it.

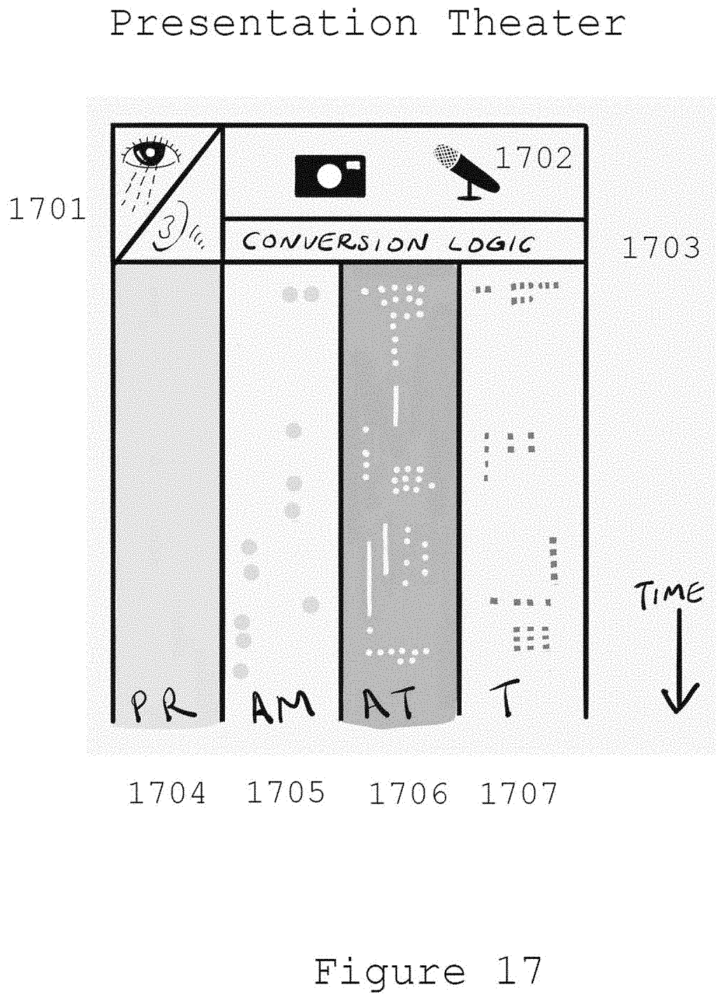

The ingestion of the scene is done through a set of miniature audio-video cameras mounted discreetly on his eyeglasses. A microphone is also mounted to receive his verbal feedback controls. For Bob, the headphones, and the neckband constitute the ‘presentation theater’ described in FIG. 17.

Alice has a severe hearing loss and operates the invention to compensate for it through her fully functioning vision- and tactile-sensors. To ingest the environmental sound around her, she is wearing a set of directional microphones mounted on her eyeglasses. (1503) The eyeglasses are a special ‘Augmented Reality’ type design that can overlay a layer of the synthesized image over the natural vision layer. The relative strength of the layers is adjustable by Alice or via the device logic while in use. In the figure, Alice is also wearing a headband (1504) that works in the same way as the neckband Bob is wearing (1502) for tactile stimuli. The set of directional microphones may be also mounted here instead of 1503. In this example, the glasses and the headband constitute the ‘presentation theater’ of FIG. 17.

The necessary logic for operating and controlling the device may be distributed among the units (1501, 1502, etc) in the way each functionality deems optimal. Most of it may also be on a separate box carried attached to the body of the user. An app on Bob's mobile phone is also an ideal candidate for the portable embodiment of the invention. All devices in the peripheral form here that manifest the ingestion and the presentation layers are assumed to have bi-directional communication established between them and the processing logic unit either wired or via wireless.

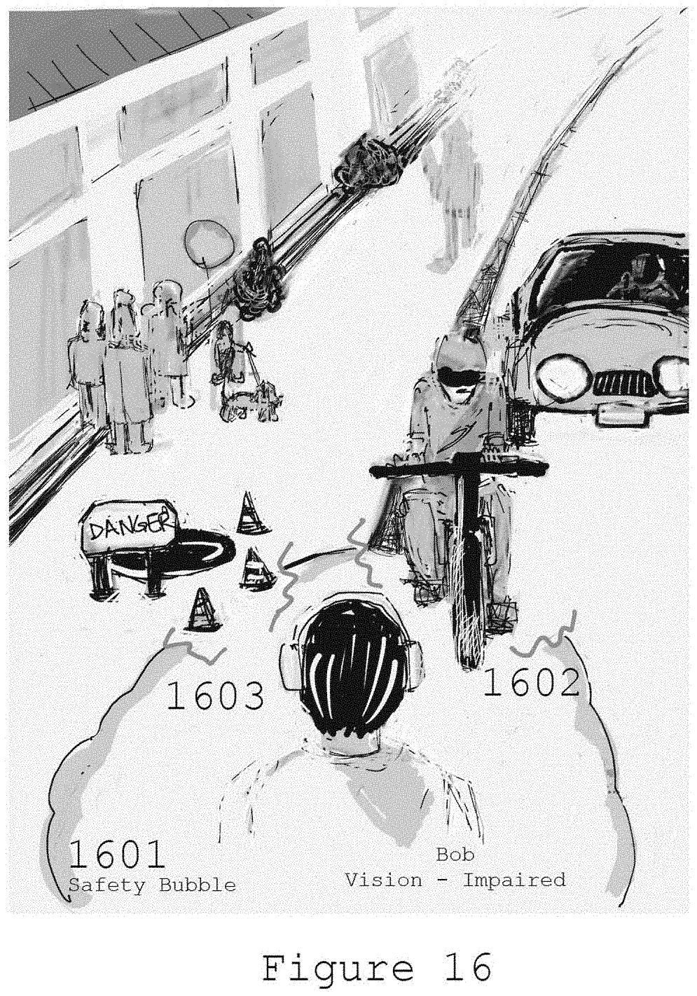

FIG. 16: The figure shows an example of the operational context that the invention aims to assist its user with. Bob, the vision-impaired user, is situated in the middle of a busy street at the bottom of the panel. The safety-bubble (1601) is a virtual fence around the user that the invention defines to detect any impending occurrence of its breach by an object or an event.

The safety bubble may not report anything notable except when Bob gets to be in close proximity to other pedestrians. To help maintain personal space, the tactile unit gently pressurizes his body in the direction where proximity is increasing. The same may be delivered through his headphones as the directional rise of the humming background noise. As soon as Bob moves to ease the proximity concern, the quiet is restored except for the occasional cues for him to be aware of the small crowd of people gathered around the dog, and someone in the far waving his hand to Bob.

As Bob walks further forward, the hazard warning cones placed around an exposed manhole (1603) and a motorcycle moving in his direction (1602) are about to breach, and the device alerts Bob about these environmental cues as soon as they are detected via presenting (FIG. 17) corresponding trans-sensory cues through his headphones (1706) as well as the tactile unit (1707). Note that such trans-sensory cues are communicated in parallel and in the sensualized form; A more measured analysis of the situation and verbalized warnings, processed by the machine-intelligence unit, may follow (1705) but with a slight time-lag when the severity of the breach warrants further detailed attention.

FIG. 17: The figure shows the ‘Presentation Theater’ in a schematic form. It is the metaphorical name for the way the user of the invention experiences the evolving timelines of the environmental cues along with the raw ingested environmental data.

The top row of the diagram shows two categories of scene ingestion: 301 indicates the primary (i.e. fully functioning) sensory organ (1701—eyes for Alice or ears for Bob of FIG. 15). 1702 shows the category of alternative ingestion devices that substitute for the user's deprived sensor (cameras for Bob and microphones for Alice). The media data ingested through them are analyzed to detect discrete, and noteworthy, environmental cues. The extracted cues are then converted to their trans-sensorial counterparts (1703) so that the user senses them through functioning sensory organs. The converted cues are sub-categorized as AM (Auxiliary Machine-Intelligence cues 1705), AT (Auxiliary Trans-sensorial cues 1706), and T (Tactile cues 1707). AT and AM are delivered through the user's primary sensor. T is through his tactile sensor, which is always assumed functional in the invention.

The lower part of the diagram shows vertical threads on which the cues are presented to the user. Each thread (or strand) is analogous to a rolling film strip (the time flows vertically down in this representation) or the rotating cylindrical comb of an antique music box. (https://en.wikipedia.org/wiki/Music_box). The score for the player-piano has some resemblance too. Each strand under the conversion logic (1705: AM, 1706: AT, 1707: T) contains dots and vertical lines in the figure. The dot represents a trans-sensorial cue that the device logic identified as a notable environmental cue at a particular time. Objects and events last for duration are represented as vertical lines.

The Primary Raw (PR 1704) strand stands for the environmental data ingested directly through the user's fully functioning sensory channel (i.e. Aural for Bob, and Vision for Alice) in raw form. The invention describes that the PR strand may be choked if the user wants to focus exclusively on the cues synthesized by the device (AM, AT). It is done through the active noise-canceling unit included as part of the user's primary sensor accessory. For example, Bob may use the headphones with active noise-canceling capability, that he uses to silence or weaken all the primary environmental sound. Likewise, Alice may use a goggle that may completely black out the outside view so that only the trans-sensory cues are visibly presented to her. Unless the situational context justifies such a drastic measure, the users are discouraged from voluntarily discarding what their innate sensor allows.

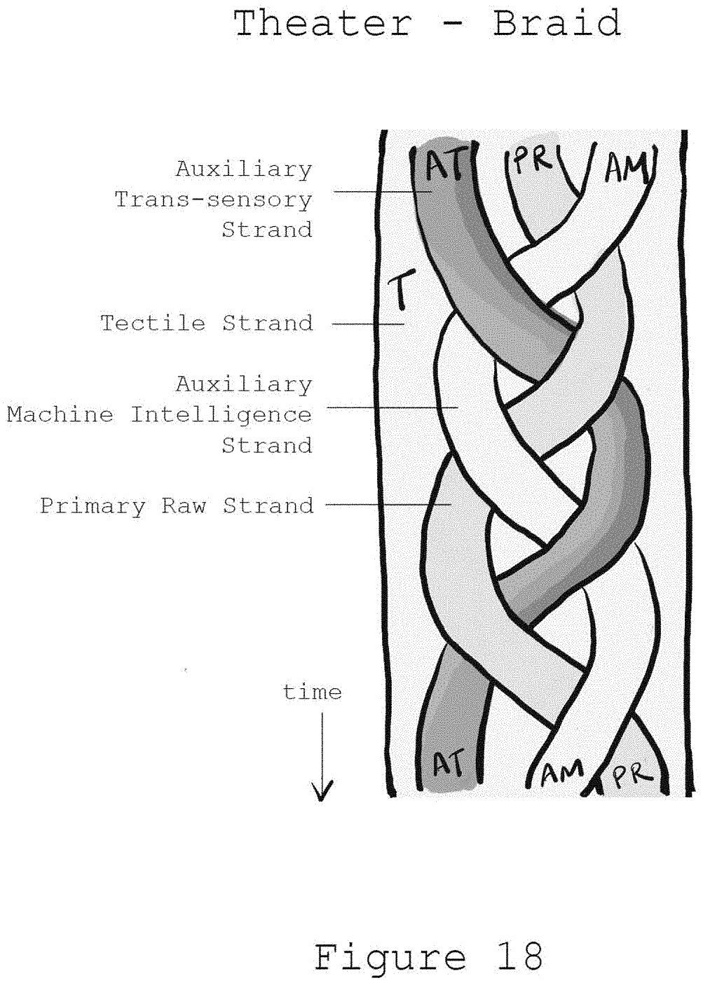

FIG. 18: The figure uses the metaphor of the theater presentation of FIG. 17 to further describe the dynamic control of pulling a strand to the fore or push it to the background. The invention describes methods to avoid sensory overload that leads to more confusion than assistance. FIG. 17 describes the four strands: AT, T, AM, PR. Note that not only is the environment dynamic, but also is the user's mind or its intention. The latter may be simply the user adapting himself to the shifting environment, but it is often the case in everyday life when the user actively shifts from one mode of behavior to another. It is done by controlling the relative weights of the strands in their rendering for the user.

For aural cues, the volume of the sound (or the intensity of synthesized stimuli for tactile cues) is the main way to control the weight. For visual cues, the weight means manipulating attributes of their visual representation commonly used—such as their alpha (transparency) values on the screen, color-vibrancy, sizes (for an icon-based rendering), and styles (plain vs. bold faces if the cues are to be rendered as text). The invention embodies the quick administration of the strand-wide weight change via a knob that, in effect, controls the twisting of the ‘braid’ that comprises the [PR-AM-AT-T] strands. In the example shown in the figure, the AT, AM, and PR strands are pulled to the foreground in turn as time evolves. (The tactile sensor is given a special status, as it is always in the background but felt by the user here).

People, free of any sensory deprivation, frequently, often subconsciously, do the same—shifting their main focus from one sensory input to another.

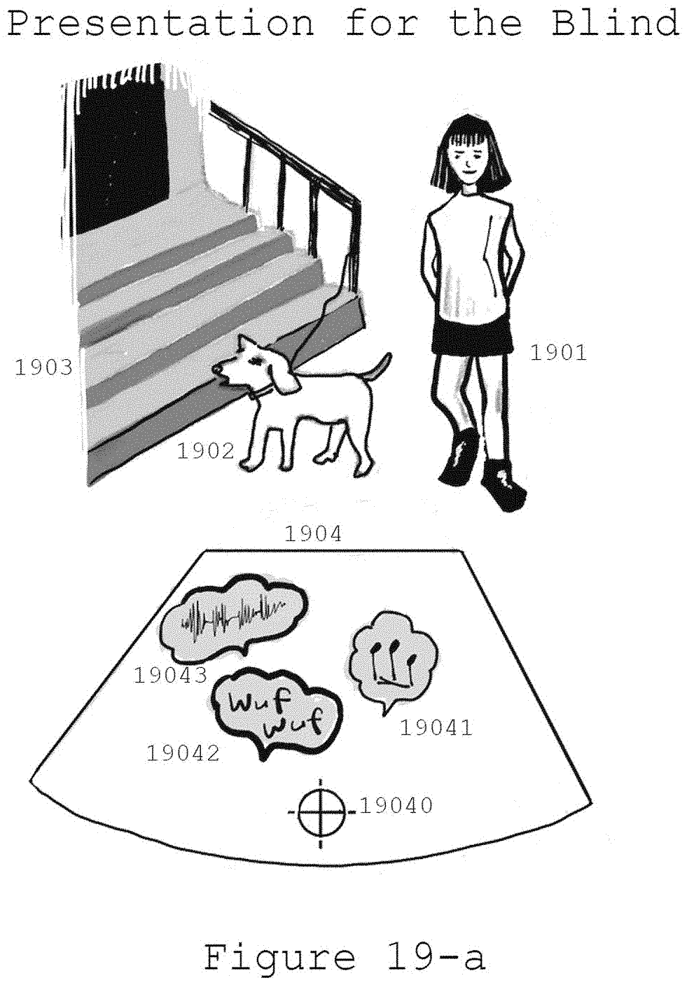

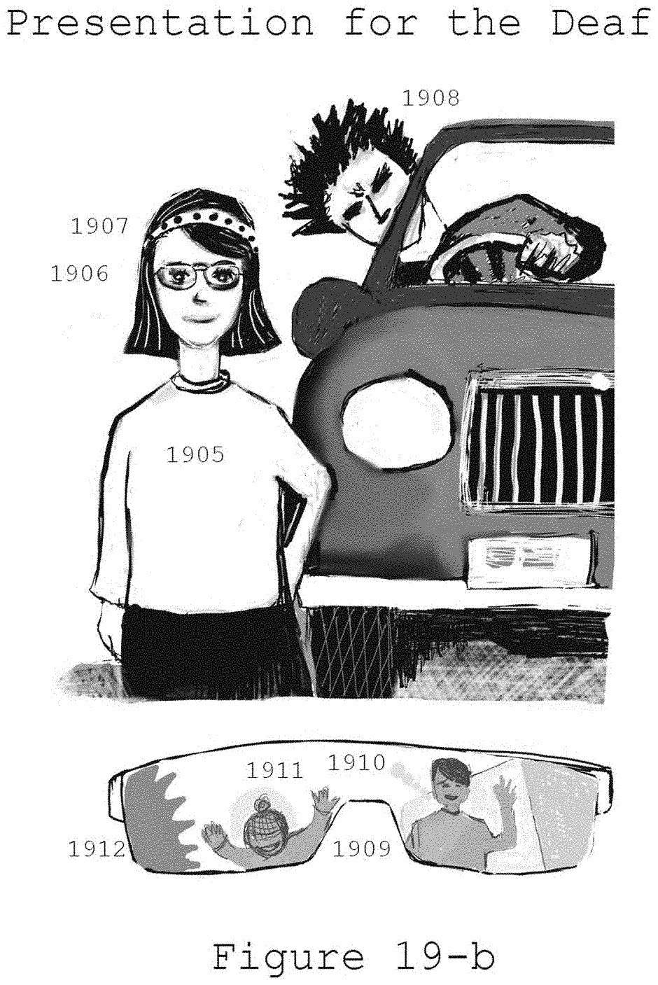

FIG. 19-(a): The figure describes how the trans-sensorial cues are presented to the visually impaired user in a typical street situation. On the top half of the panel, we see part of a building with four steps 1903, a dog 1902 in front of it, and a woman 1901 standing nearby to the right. Thanks to the stereoscopic vision, we intuitively get a rough sense of distance to each of them. On the bottom panel, Bob 1501 would ‘read’ the landscape through his headphones which functions as the presentation theater of the invention. In the truncated-cone shaped aural space 1904, Bob is placed at the bottom center 19040, and the device plays three aural cues that represent the objects as identified above by the conversion logic. In rendering them, the presentation logic adjusts the individual volume and its left-right balance of each soundbite to reflect its location with respect to Bob's position. In this example, the preset dictates that the dog is represented by a short ‘barking’ soundbite, the woman by a few musical notes of a viola, and the four steps for the building entry by four doses in quick succession of the synthesized tone. The tone would have been designated for the generic step in the building by the preset which the user is assumed to be familiar with through the training for the use of the device. Once detected, the device logic tracks them and renders them at regular intervals reflecting their ongoing status—some may fall out of the user's scope or the system logic decides to revise their representation.

FIG. 19-(b): The figure shows the counterpart of FIG. 19-(a): The hearing-impaired user 1905 is standing near the traffic lane watching her family members nearby, apparently unaware of the car approaching her from behind as she cannot hear anything. If she is the beneficiary of the invention, she would be wearing the augmented-reality glasses 1906 (and the head-band 1907 for the tactile sensing). Through the glasses, she will primarily see her child and the father playing. The happy noises they make may be reflected in the form of understated color blobs of yellow (shown light gray in the figure) 1911 (laughter) and green 1910 (speech bubbles) overlaid on the scene. For detected speech, it may also be transcribed in text and scroll at the bottom of the screen view in a more advanced embodiment.

At the same time, the noises from the automobile and its driver getting too close would trigger the device to display an alert blob in red color (shown dark gray) 1912 on the side of the glasses matching the direction where the sound is coming from.

By nature, the locational precision of the aural cue is not as high as the visual cue in general. That may constrain the efficacy of the invention (for the visually impaired) in the faithful presentation using the aural cues, and (for the hearing impaired case) in determining the precise source location at the ingestion stages. The availability of better-designed hardware (an array of multiple directional microphones) and the 3D audio synthesizing and reproduction technology address the issue.

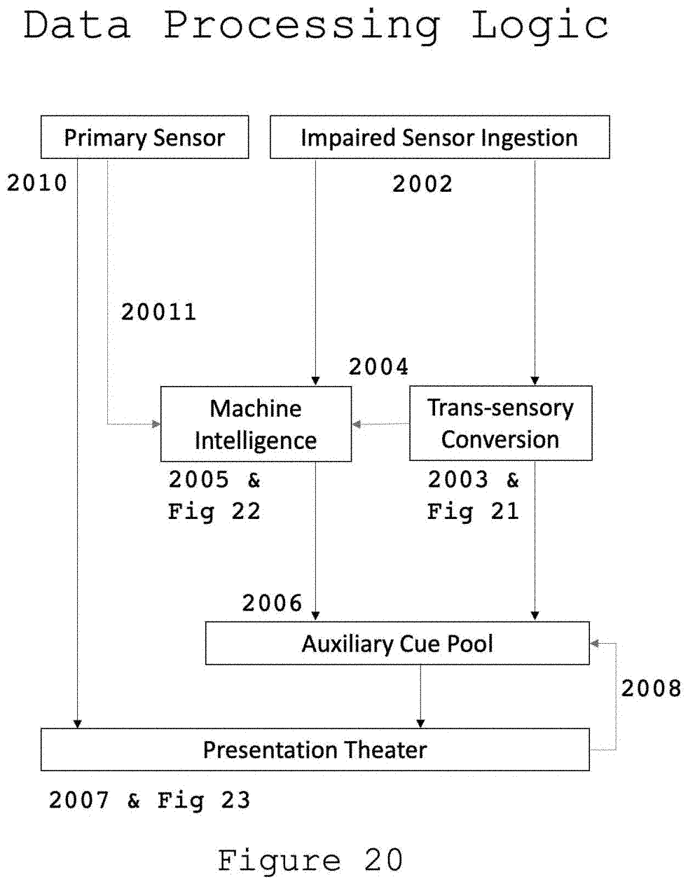

FIG. 20: The figure describes the bird's eye view of the logic flow for the invention from the sensor-hardware to the presentation theater that is the final interface between the environment and where the user's cognitive neural pathway begins.

Both the visual and aural components of the environment are to be fully ingested through the primary sensor of the user (2001—the eyes of the hearing impaired, the ears of the visually impaired) and the sensor/recording devices (2002—video cameras and microphones). The data from the Primary sensor is passed on directly to the presentation theater (2007). At the same time, it is also shared to the advanced machine intelligence unit (2005) that runs either on the dedicated onboard logic unit or farmed out to a remote device or service via the network connection. The purpose of engaging the ever-evolving machine intelligence logic is to extract a high-level knowledge from the raw media that is beyond human capacity either in time scale or in the depth of details such as recognizing an object on the street and retrieving its details from online encyclopedia in a blink. The unit 2005 generates cues from such analyses and pushes them to the Auxiliary Cue pool 2006, which is a clearinghouse for all such synthetic cues served on the first-come-first-served basis as the presentation theater 2007 renders the cues superimposed with the primary sensor stream 2001. Upon presented, the cues are removed from the pool 2008.

In parallel, the stream of data from the sensor devices that substitute for the user's impaired sensor 2002 passes through a lightweight computer-vision operation where it identifies and collects environmental cues that are of potential interest to the user. The cues accumulate in a holding-queue (a few frames of captured images or a segment of audio recording lasting for more than a few seconds). On one hand, these are passed on to the advanced machine intelligence cue 2005 where they follow a similar path to that of 20011 as explained in the previous paragraph. On the other hand, each individual image frame or audio slice is also sent to the trans-sensory conversion 2003 in which all cues found therein are mapped to their counterparts in the other sensory form and added to the pool (2006).

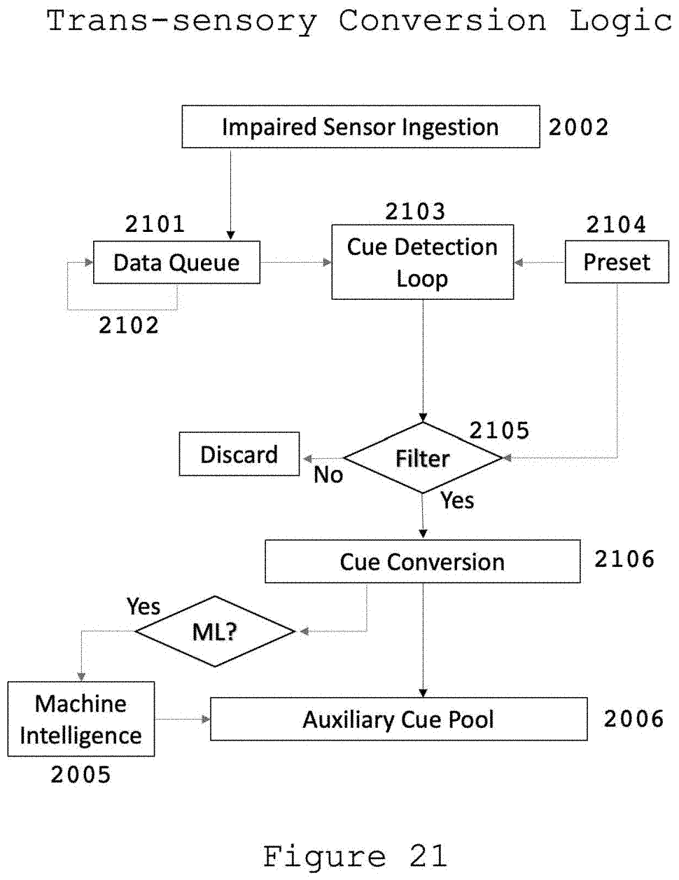

FIG. 21: The figure shows the details of how the trans-sensory conversion logic works in the trans-sensory conversion block 2003. Whether the substituting sensor device is an array made of video cameras, or of ultrasonic proximity sensors or of microphones, their input is accumulated in a holding queue (2101). The queue sends each segment to the cue detection loop 2103 on a first-come-first-out basis. As each segment leaves the queue, it allows new data from the sensor to be added to it. It also monitors and controls their in and outs through calculated culling. The main purpose of the housekeeping 2102 is to prevent the downstream logic operations from becoming overloaded.

The Cue detection loop 2103 applies the suite of standard image processing and machine intelligence logics (collectively termed computer vision—CV—operations) to detect notable objects and events, their elementary traits such as size, location in 3D space, etc. The detailed selection criteria and analytic scope are set by the Preset 2104 of the embodiment. Each identified environmental cue then sent to the filter unit 2105 which scores them for relevance (set by preset 2104). The cues that pass the filtering progresses to the trans-sensory conversion 2106. (from the visual to the aural or the tactile form of representation if the device is used for the vision-impaired, for example) At the same time, the Preset is queried to determine whether the cue merits more advanced machine learning analytics. If so, it is sent off to the machine-intelligence thread 2005. Finally the trans-sensory cue is added to the appropriate strand.

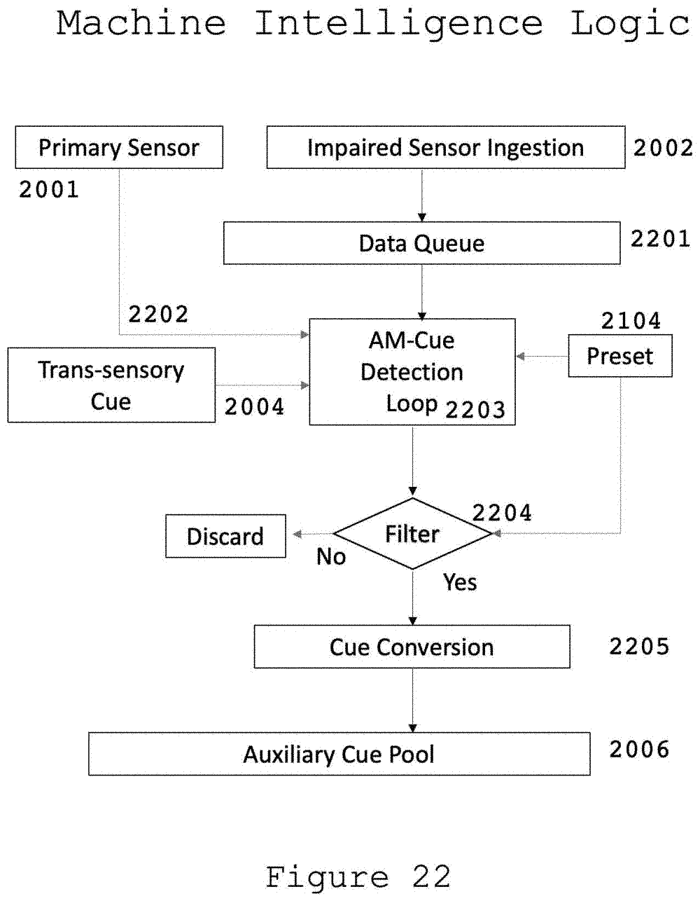

FIG. 22: The figure shows the details of the advanced machine intelligence logic workflow. The central Auxiliary Machine-Intelligence Cue (AM-Cue) detection loop 2203 (or module) imbibes the data from three distinct ways. This is large to keep the device logic open to rapidly evolving machine analytics future-forward. One source of the ingredient is from the primary sensor 2202. Note that it is an innately accessible part of the environment that the user can directly sense and apply his own intelligence. In addition to adding more value that is only possible through the machine/network analytics, it can be used to correlate with the other sensory aspects of the same origin, and thereby enhance the quality of the cues that have interpretative content such as an event or mood. For example, the sound of laughter and the smiley face of a person, when put together, lead to the more reliable identification of a happy person. The sight of a gun and the sound of its firing, in their temporal and locational correlation, gives an unambiguously urgent safety warning.

Therefore, the invention provides the portion of the primary sensor input 2202, a queue-full of alternate sensor input 2201, as well as the trans-sensory cues that its light-weight conversion layer has identified 2004. They all converge at the Cue detection unit 2203, which then applies the suite of machine learning and other techniques in the way and scope prescribed by the Preset 2104 and extracts noteworthy 2204 trans-sensory cue(s) 2205. Once generated, the trans-sensory cue may have extra details about the environmental cue that it is representing. Or it may contain some ‘insight’ that only the machine could obtain through cross-analyzing various correlated cues that escapes the user's notice. These cues take longer time, consume more resources, and are generally difficult to convey without hogging the limited cognitive capacity of the human being.

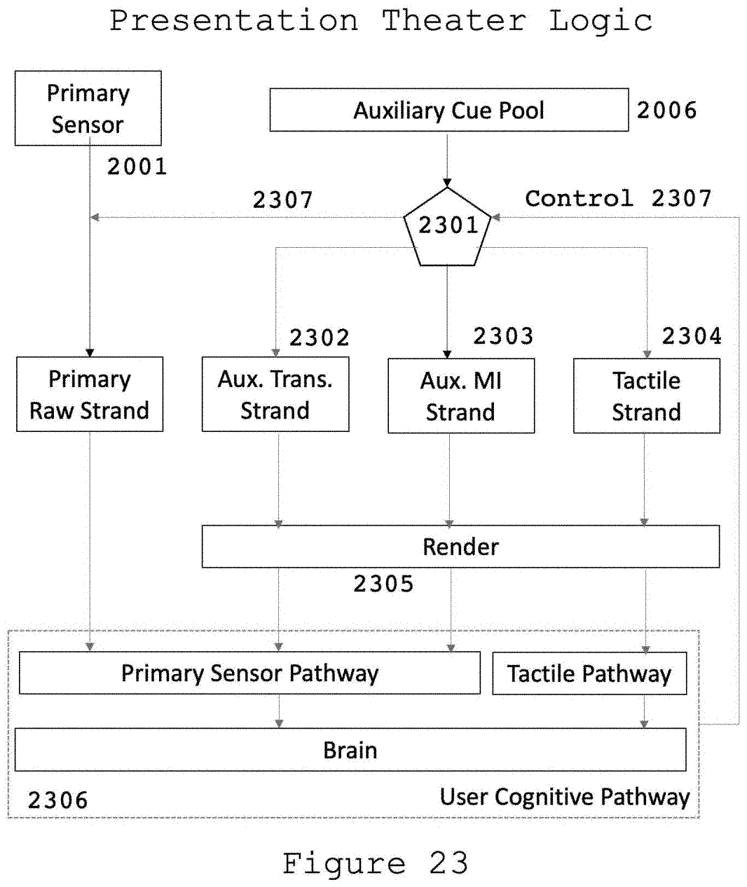

FIG. 23: The figure describes the invention's logic that consolidates all environmental data and renders them, in a way that is reminiscent of a typical movie theater or music hall experience, to the user immersed at the center. At any given moment, the material to compose the final rendering enters the logic unit from two sources. One is the user's primary (functioning) sensor 2001. The other is the auxiliary cue pool 2006 which is a temporary depository of all cues generated by the preceding logic processes (FIGS. 21-22) using the trans-sensorial conversion and to be consumed at this stage. Some cues, even though based on the shared set of contemporaneous raw material, may get generated by the conversion logic and arrive at the Cue Pool 2006 with differing amounts of time lag. The sorting unit 2301 continually runs a book-keeping operation to order, cross-correlate, and eliminate redundancy among them. For example, by applying the temporal-granularity criterion and proximity-based reduction of the group of similar cues to the single “aggregate of” cue, the logic at this stage may reduce a significant amount of clutter. The sorting unit then dispatches each of the surviving trans-sensory cues to the relevant strand (2302-2304). The renderer unit (2305) then renders them using methods such as screen-rendering, audio-synthesizing and haptic stimuli generation. The rendering of all cues for the unit time step of the rendering or device refreshing cycle occurs two-fold: One is the layers of the user's primary sensor canvas. The other is the user's tactile sensor canvas if the user/device employs it. From these two sensory canvases, the curated environmental data and cues enter the user's brain that takes appraisal of them as a whole and takes action.

Finally, as time evolves, the user's need and environmental contingencies make it necessary to shift his focus quickly from one facet of the environmental portrait to another. The device logic and control to facilitate it is described as twisting the braid comprising the strands (FIG. 18). The user administers this by turning a knob thereby initiating prescribed changes in the book-keeping logic and the rendering protocols via 2307.

Synesthesia: The phenomenon of Synesthesia occurs in about 4% of the population. Historically it has been viewed as an affliction that induces in the affected individual the ‘joined or coupled sensation’. Examples include the cases such as when hearing a musical note induces the visual sensation of seeing a particular color; also a shape of an alphabet for a color. The transfusion occurs also within the same sensory domain—such as vision—across its subdomains spanning Alphabets, shapes and colors.

An experiment involving the shape-color synesthesia showed the numeric symbol 7 among the cluster of 2's (all of the same color) in the test subjects' peripheral vision field. Of the subjects, the synesthetes detected the presence of 7 far better than the normal peers. The superior detection performance is shown to be the result of distinct colors (green for the 7's vs. the orange color for the 2's induced in synethet's vision).

Many artists afflicted with synesthesia from early ages report that they trained themselves to take advantage of the expanded cognitive pathway to their advantage.

An example of the trans-sensory conversion that assists the visually impaired people read the book is Braille, the tactile system invented in 1824 by Louis Braille, By replacing the alphabets in the printed books by the patterns of embossed dots, the invention takes a page (the stream of printed text) off the book that was originally meant to enter the reader's cognitive pathway through vision, but steers them instead through the tactile path. This works rather well because the task (reading text) is narrowly defined, the material pre-converted, and the user pre-trained.

Outside of the reading room in the library, a fully perceptive person is bombarded by the multi-sensory stream of environmental cues such as the street signs, buildings, automobiles and other pedestrians. There are also cues that carry depths of details, many of them dynamic—such as a moving car popping in and out of the person's perception. There are also intangible ones—events, actions and meanings that become apparent through higher-level appraisal of the whole. An event arises out of the confluence of many elemental cues. An action occurs over a certain period of time, and thus requires processing of cues and their correlates across time. The ‘meaning’ of a scene is generated at the intersection of the subject's mind in its collective appraisal of all cues that entered his cognitive pathway, each sharply in focus or as a peripheral presence.

For the sensory deprived, one of the major gates is shut, and the loss is incalculable. Not only are the cues that are meant for the deprived sensor lost, but higher-level intangibles that the mind derives through correlating multiple cues that enter through different sensors are also compromised.

The invention, in its primary motivation to help the sensor-deprived people achieve competence in the wide range of tasks draws inspiration from such aspects of synesthesia and the example of Braille that demonstrate the agility of the human mind. In particular, the potential benefits of ‘restoring’ the blocked path (via the trans-sensorial conversion) at the early stages of the cognitive pathway is identified as a key aspect that motivates the invention. In that way, the user has access to the massive amount of environmental cues in a way that does not further obstruct his constricted cognitive pathways. The beneficiary of the invention may compete in many mundane tasks at levels on par with their unafflicted peers, when he is properly trained in the art of operating the device in which his own intelligence, having the near-complete access to the low level environmental cues, play the active and complementary role rather than fully subordinated to a machine-centric assistant device.

Trans-Sensory Conversion: The invention borrows the sensory fusion aspect of the biological synesthesia in its embodiment, practically giving the user a substitute for his impaired sensory channel but its stimuli transcribed in the synesthete-like manner. The impaired sensory organ is now replaced by the ingestion device (a video camera for the visually impaired, a set of microphones for the hearing-impaired) with a lightweight machine-intelligence logic placed between it and the user's functioning sensory organ(s). The logic layer first applies the computer vision (CV) logic and other prescribed by the contextually defined preset (see below) to identify noteworthy environmental cues and maps them to their counterparts in the collection of ‘trans-sensory’ cues.

Operational Context and Presets: The context for the operation of the device may be conditioned by applying a predefined preset that the device maker or the user chooses. The preset is essentially a container for parameters that pre-conditions the trans-sensory conversion logic: it determines the overall mode such as ‘home’, ‘street’, ‘outdoors’ to give an example. It also sets the scope by specifying the objects and events to identify as well as their details threshold—hierarchical depth and granularity. The preset is also used to set the aspects of the collection of ‘trans-sensory’ cues to use. In modern day computer operating systems, the practice of allowing the user to modify and apply different color schemes or styles of the visual interface components is generally called changing the ‘skin’. Customizable options that the user and the designer of the system have in how to represent the trans-sensorial cues in the alternate sensory channel is akin to the practice of applying a skin.

Ingestion, Processing and Presentation: Drawing an actionable decision out of the sea of dynamic environmental cues is an outstanding challenge for the most advanced machine intelligence analytics. On the other hand, even a child easily satisfies all its requirements: accuracy, timeliness, depth and scope.

The observation motivates the invention to seek maximal utilization of the user's own intelligence across the whole span of his cognitive path in compensating for his compromised sensory capacity. The invention builds on the notions of operational context, environmental cues, sensory channels, and cross-sensory conversion (or mapping). By supplementing the user's primary (i.e. fully functioning) sensory input with the trans-sensory cues, further augmented by the higher level machine-intelligence generated cues, the invention funnels them into a representation of the evolving landscape all conducive to the user's functional sensory organ(s). It presents the multiplexed timeline of cues in the virtual theater. The sensor-impaired user watching this from the center of the theater experiences all that his functioning sensor allows with additional trans-sensory cues superimposed on a side track that are otherwise missing due to his sensory deprivation. Schematically, three sensors—vision, aural, and tactile—are involved. A typical beneficiary of the invention is deprived of one of them, the other two intact.

The invention emphasizes that when the trans-sensory environmental cues are synthesized, their form is for entry to the earliest possible stage of the user's cognitive pathway. Practically speaking, trading a colored dot on the pigment of the visual cortex for a millisecond of aural tone does make no sense. Instead, the trans-sensorial conversion of the invention uses the layer of computer vision (CV) logic to extract from raw data the environmental cues in their simplest yet symbolically non-trivial form.

This emphasis goes against the grain of the currently existing machine-intelligence centric assistance devices: In a typical device, the user is left in the dark regarding the blocked sensory input until the logic unit processes the hijacked data and reaches the high-level conclusion. Finally, such a device delivers its recommendation as a verbal message, e.g. ‘A car approaching. Proceed with caution.’ Such verbal instructions are typically experienced in the navigation systems in automobiles. Such a turn-by-turn verbal instruction is effective, whether the user is sensor-deprived or not, in the narrowly defined operational context. It is apparent that it becomes increasingly less effective in the complex dynamical environment where contingency is the norm including the user's own intention and where a lot of things happen in parallel.

In the current invention, the user's own mind is allowed to work alongside the machine intelligence, having access to the whole environmental cues all the time and throughout the entire cognitive pathway. The sensor-deprived user ‘reads’ the entire landscape from the center at the presentation theatre invention as the invention delivers in the form of the multi-stranded timeline carrying cognitive contents. To push the theater analogy further, the experience is like watching a multi-tracked film, carrying close captions, main images and soundtrack, a screen-in-screen sidetrack—but all transmuted to a grand symphonic music for the visually impaired.

The whole ‘stream’ comprises the raw input though the user's functional organ, and the auxiliary strands that carry the trans-sensory cues and the machine intelligence based recommendations. The confluence of the strands occur at the theater, and when the user imbibes each temporal slice of them, the cues enter his cognitive pathways for their full human-interpretation. The superposition of the synesthetic cues does not ‘block’ as much as a verbalized driving instructions do, and it makes the cues amenable to the brain's parallel processing power, i.e. what one may call an ‘intuitive’ grasp of aggregate factoids, priorities, and multi-time scale events.

To be concrete, the embodiment of the invention tailored for the visually impaired user will be used in the following. The case for the hearing-impaired can be easily obtained by switching between the visual and the aural.

In a nutshell, the invention ingests the full audio-visual sensory stimuli, takes the portion that is blocked for the sensory deprivation of the user, extracts environmental cues contained therein by applying machine intelligence logic, makes trans-sensory conversion to their synthetic representation. At any given moment, the raw primary data and the converted cues are consolidated and presented through the user's primary sensory channel. Collectively, they represent the virtual reconstruction of the environment (or cognitive landscape). Their consumption resembles watching (or listening to) a multi-tracked film (or music) in a fancy presentation theater. Each track (or strand) carries either the raw input or aggregate trans-sensory cues. In the following, each of the strands is described.

The primary sensory channel available for the visually impaired person is auditory. The pristine environmental sound is faithfully ingested (either as part of the video capture described below or as a separate entity) and passed down to the ‘presentation theater’ in its ‘Primary Raw Strand’. The user's own voice input (user generated sound) and the ambient sound are best if isolated from each other early on in their travel down the user's cognitive pathway, and subject to a controlled noise-canceling logic.

The blocked channel for the visually impaired is vision. The lost data in this channel is then analyzed and converted to trans-sensory cues fit for the user's primary sensor (audio in this case) as well as his tactile sensor. These trans-sensory streams join the presentation theater in the ‘Auxiliary Strands’ bundle. The ingestion of this lost data is done through a depth-sensing video camera. The device may be worn by the user (headset, eye-glasses, necklace, or a mesh of miniature cameras embedded in various parts of dress). The ingestion unit(s) may be physically separate from the logic- and the presentation-units or integrated with them to form a standalone service device. In the former, the logic may reside on a dedicated device or on the user's mobile phone device if it is capable.

Processing logic applies the set of logical steps that include identification of noteworthy environmental cues, namely objects present and events happening in the scene. It also derives their attributes deemed relevant by the preset—such as the item's location in 3D, velocity, correlates with other cues, if multiple ingestion devices allow such an inference for enhanced accuracy. These cues are then converted to the user's primary sensory form (aural for the vision-impaired) and fed into what is termed ‘Auxiliary Trans (Sensory) Strand’ of the presentation theater in the invention.

The vision data stream is processed more extensively to obtain higher level information as well as finer details about them. To do so, the raw video input is channeled into what is termed ‘Auxiliary Machine Intelligence (MI) Strand’ of the presentation theater in the invention. On this channel, advanced computer vision (CV) and machine learning (ML) operations are applied on-board or farmed out to external service providers and obtain the analytic results via asynchronous communication to avoid hindering the latency-averse Auxiliary Trans-sensory and Tactile Strands.

The system designer or the user may prefer to use the user's tactile sensor as the destination for some types of the trans-sensory cues (and/or the Machine intelligence derived ones). The ‘Tactile Strand’ refers to the haptic device (or multitudes of them) worn on the body of the user that can present the set of prescribed haptic stimuli with their patterns mapped to represent a set of environmental cues for which the preset deemed more appropriate to propagate through the user's tactile perception.

For some attributes such as fine-grained facial features that consume a significant amount of computing resources (whether on-device or on a remote “cloud” server), their logic operation request is dispatched as an asynchronous network operation. The operation carries the identifier for the request as well as the object that initiates the order so that intelligent management of delayed results upon their arrival.

Placement of the identified objects in the 3D real space and their representation may use either the absolute- or the relative-coordinate system. For example, when the user (wearer of the device) turns his head (or body) from one direction to another, the device logic adjusts the placement of source for each audio cue in the aural landscape to accurately reflect its presence in real space as the pair of ears would perceive. The device may dynamically switch between the relative and the absolute modes either on users command or autonomously if the device logic is capable of detecting the change of operational context by advanced analytics of the monitored environment.

Shift of User Focus—The Theater as The Braid of Strands: The output of the embodied invention is a bundle of multiple strands, each of which is a stream carrying the environmental data in various forms. At a given moment, the user watches (hearing-impaired) or hears (visually-impaired) the time slice of the bundle. The human mind nimbly shifts its focus from one sensory channel to another. It does so from one area to another even within the single sensory channel. Likewise, the invention allows easy shifts from one stand to another by two mechanisms. One is by twisting the bundle and the other is by pinching the strand. By ‘twisting the bundle’, the invention brings one strand over (i.e. forward) others. It is done by muting or highlighting the physical manifestation of the cues in each strand according to its forwardness. To mute an aurally presented strand, its forwardness value is set to zero. While the strand is muted, all cues in it are not rendered. To highlight a strand, the user will operate a control to bring its forwardness value to a higher value. The cues in it are rendered in a more pronounced manner, while others diminished. ‘Pinching’ a strand effectively throttles the output on the affected strand (this applies only to the auxiliary strands that carry synthetic cues) by changing the filtering criteria for the cues sent to it. When the trans-sensory cues are generated, each of them has to pass the prescribed filter which determines how noteworthy it is for the user in the given operational context (as set by the preset selection). For that purpose, a scoring sub-logic operates as part of the conversion logic. Only the cues that get the score exceeding the threshold value are pushed onto the strand. The rejected ones are discarded as noise. ‘Pinching’ the strand effectively raises the threshold value for the passing score, effectively reducing the number of cues that appear in the strand. As a result, the pinched strand is sparsely populated.

For example, the controls for the presentation theater therefore include mute buttons for each strand, a rotating knob to bring one strand forward over others, and a pinch slider for each strand. The trained user develops artful skill of maneuvering these controls in real time to shift focus, blackout unwanted cues, re-balance between using his own intelligence and relying on machine-intelligence.

Mapping of a Cue and Its Presentation: The embodiment of the invention changes its ‘skin’ on its presentation theater by making a choice from the suite of representational schemes for the trans-sensory cues. In its simplest form, the scheme uses the simple one-to-one mapping. To elaborate, if the conversion logic identifies an object as ‘chair’ in the ingested channel, it is assigned to an instance of the generic ‘chair’ class. Each generic class defines the set of attributes. There is a set basic attributes that all classes mandate for their instances. For example, a unique identification number, its location, size and the set of time-stamps for when it first came into view of the device and when it exists. Then there are secondary attributes such as its color.

Continuous dynamical attributes of objects such as distance, location, size, velocity are inferred from the depth-field map (if available) and tracked using the optical flow logic, a well-established computer vision technique to track movement of an identified object in the visual field. They are important components to express dynamism of the scene in the user's environment. With 3D audio technique, the movement of each object is reflected in the aural cue by moving its source location in the virtual space as the sound is synthesized. Dynamism of an attribute is generally expressed by modulating its waveform in the prescribed way.

This way, the invention communicates the comprehensive dynamical information of the user's immediate environment through multitudes of trans-sensorial cues. At the coarse grained level, using the intensity and the source location for each aural cue gives an instantaneous bird's eye ‘view’ of the landscape that the user is trying to navigate.

Plurality and Aggregation: If objects of the same class are found in close proximity to each other, they are lumped and assigned to a crowd object instead. For example, consider a street scene: details of individuals far from the user are generally of little interest except for their overall presence and general direction of their movement. Such a group of objects merits the coarse-grained representation. The trans-sensorial cue for a crowd of unidentifiable people is expressed as a soundbite of murmuring noise with a hint of whether it is receding from the user or approaching by its source relocation in 3D audio or a Doppler shift in pitch.

The example shows the trans-sensorial mapping of a multitude of objects to a single aggregate object. The many to one reduction has useful implication in the presentation theater as it prevents the aural landscape from being cluttered with redundant cues—mostly noise.

Synesthetic Cue Representation: The synthetic cues for the invention are designed and deployed through the auxiliary and the tactile strands. They are designed by consideration of brevity, recognizability, flexible granularity as well as their aesthetic quality. A critical consideration is that it is generally preferable to avoid sensory overload which may happen in complex operations where multiple objects and events may generate a river of cues with each varying in color, texture, size, shape, motion, and contextual meaning.

For an embodiment used by the vision-impaired, both the aurai and the tactile-cues are to be considered. For the hearing-impaired, it is instead the vision- and the tactile.

The basic aural cue is a modulated and textured tone. Alternatively, it may be a brief audio clip or a musical gesture. Pure tones, while simple, may be combined to generate a rich set of harmonies, melodies, gestures, etc and therefore a good candidate to be synthesized in-situ and used. Augmented by a collection of sampled clips of nature—such as a bird tweet, dog barking, a motorcycle engine, and ambulance siren, the palette of aural cues gets rich enough to generate a symphonic, if somewhat cacophonic, impression of the typical street scene. Presented in the 3D audio theater, assuming that the processing logic and the user's headphones are capable, each of the cues can impart the faithful sense of where it is in the scene.

To give a concrete example in which the mapping between the visual- and the aural-cues uses the musical system: Textures of different musical instruments are used to categorize objects. The violin for a woman, cello for a man, piccolo for a child. The set of variations in pitch, gestural ornaments, rhythmic variations alone accommodates imparting the subject's age (pitch), emotion (vibrato). It also allows a many-to-one or one-to-many mappings: When multiple individuals are identified but lacks any distinguishable traits for the user's interest, they are aggregated into the “crowd” cue, for which a single aural cue is used that sounds out an ensemble of notes (hopefully in good harmony). Conversely, a one-to-many mapping merits in situations where an entity is identified in proximity and also carrying other isolatable articles such as a weapon or a pet. A person nearby carries multiple attributes such as facial expression, gender, rough age, hair color. It is in the art of designing the palette for trans-sensorial cues to further accommodate those details in a tractable way.

The trans-sensory cues for the hearing-impaired are mainly in the visual form. Their presentation theater comprises augmented-reality eyeglasses or goggles. At its barebone form, a semi-transparent blob of a specific color is superimposed on the user's visual field, preferable on the location that is to match as closely as possible to that of its source on screen. If the source of the original cue is outside the field of view, i.e. back or from far outside of his peripheral view, then the blob may be rendered on the appropriate edge of the screen. The color and intensity of the blobs are similar to the aural tones and their volume. However, due to the intrinsic difference and limitation of the sensors involved, the methods to present fine-grained details may differ. The priority of the user may also differ in general as each type of sensory deprivation affects the afflicted in a different manner.

When the primary motivation for using the invention is for safety on the street navigation of a hearing deprived person, ingestion of all detailed aural cues in the front area would be of lower priority than getting alerts of an impending truck about to breach his safety bubble from the rear side. For unafflicted, such warnings are most effectively ingested by its loud noise, for which the invention substitutes with a large blob of red color at the bottom of his screen which grows intensifying in intensity as the breach gets near. At more leisurely moments, the same device operates to convert and present details of bird tweets and the happy sound children make in the part in the form of multiple but understated color blobs floating on the user's screen.

Finally, the invention generally assumes that the tactile sensor is always available for the user. The trans-sensory conversion logic and the preset of the device allow designated subsets of cues use the tactile channel (when the appropriated presentation methods are detected as available). Engaging both of the available sensory channels is useful in situations that demand the user's primary sensory pathway be free of any distraction (even if they are useful trans-sensory cues) so that the user maintains intense focus on using his intrinsic sensory capability.

For example, consider a visually impaired user going for a stroll in a pastoral environment. Should he want to use his headphones to enjoy music, he would avoid compromising his safety by wearing the tactile sensor. The invention is then set to the mode where most of the trans-sensory cues take the tactile route to be presented, maybe except for safety related cues such as the safety bubble breaches.

Cue Management for the visually impaired: For efficiency and to keep the conversion logic lightweight, the system logic may use an internal logic to monitor the frequency, duration, and proximity of cues of each type and dynamically optimize their management under the given operational context. The conversion logic uses the following temporal and object granularity-based reduction methods and prevents the user's trans-sensorial landscape from being saturated or overloaded by repetitive occurrences of cues of certain types. These methods are to be controlled by the user as well as by the device system logic in real time.

Temporal Granularity—The visual data ingestion typically occurs at 30 to 60-frames per second. At regular intervals, the ingestion logic examines the image of the frame and identifies the objects that are among the types of its interest set by the preset of the device. Once recognized, each freshly identified object gets assigned a unique identification and tracked across the successive frames to update its basic attributes such as location, sizes, etc. Events within the device's scope of interest are identified by monitoring the select set of objects and their attributes; dusters of these cues are passed through a specialized sub-logic unit to identify any notable events. Thus identified, the objects and events are converted to matching trans-sensory cues.

Duration of an audio cue is brief but long enough to sound pleasant to the ears. If too long, it fails to keep up with the natural dynamics of the source object/event. Avoiding redundancy (i.e. same audio cues fired too many times) is critical, but occasions arise where a quick and repetitive firing of progressively escalating cues is effective as an urgent alert. The system logic may further refine the duration of the cue so that they are updated and repeated with an appropriate temporal granularity and avoid confusing the user. To find appropriate duration time of frequently occurring cues, the invention describes a method that keeps track of their uniquely identified occurrences and duration of existence in the strand. This allows the logic unit to adjust the interval of their firing to reduce redundancy.

Object Granularity—If there are a few people in the room, the invention generates as many trans-sensory (i.e. audio) cues as it identifies, and presents each audio cue as emanating from its location in the 3D audio scape that reflects the physical location in the room. In a crowded place, far too many people may exist within the device's scope, easily saturating the cognitive capacity of the user as well as the device capacity. In such a situation, the conversion logic maps the multitude of similar objects to just a single “aggregation-of-people” cue of the same kind. The determination to proceed with this many-to-one mapping uses the prescribed set of predicates, based on the proximity criteria. The proximity conceptually extends to aggregates of general types: such as those sharing the uniform direction of movement, or sizes, shapes, etc.

Feedback and Interactivity

When the user spots a cross-sensory cue and decides to focus on its details, he ‘selects’ the item and ‘engages’ a gesture or a button to invoke the ‘more info’ function. The selection mechanism for the hearing-impared case is as follows: the device is displaying the cue—a visual icon representing the sound it detected—in the appropriate location in his AR-goggle or glasses. The user orients his head in a way to bring the object to the center of the field of view on screen, and hold the gaze. The device places a lock on the item and query the user for confirmation. Upon the user making the nodding gesture, the device brings up a detailed description of the sound. This ‘More Info’ function fetches the detailed attributes of the cue that had already been acquired as part of the trans-sensory conversion by the machine intelligence logic but kept out of the stream due to the granularity control. If necessary, it also initiates an asynchronous information-acquisition process, a part of the advanced machine-intelligence logic operation. When such a queried information is acquired at a later moment, the device may proceed to append it for display, if the user's attention is still on the cue and the cue is within his perception.

A more advanced application is to employ eye-tracking technology. (applicable only for the visually-impaired who still retains the muscular control of the eyeballs.) In this embodiment, the eyeglasses that the user is wearing mainly to mount the camera and control elements, also tracks the orientation of his eyeball. By tracking its movement with precision and the internal mapping logic, the device infers the item of the user's focus, and follows the information acquisition process described in the preceding paragraph.

The mechanism allows the user to make the device expose progressively deeper layers of information on a given object or event based on the user's need. For example, when the blind user is out on the street looking for a building with a particular number or other attributes (tall victorian house with red-colored window frames), he may first quickly find his way near the zone using the coarse-grained mode of trans-sensory conversion, and then narrow down his quest by zooming in on details of his immediate environment.

The invention describes a way to separate the sound generated by the user (e.g. human echolocation purposes) or by the device, and to use it in the Primary Raw Strand for human echolocation, and the Aux MI Strand for Siri/Echo-like AI commands) other than channel Aux Trans-sensory Strand.

The invention also describes how its conversion logic can be used as the machine-augmented echolocation technique: The echo bouncing off the obstacles is captured by an array of hyper-sensitive microphones and further optimized—cleared, amplified, transformed, and cross-analyzed with the contemporaneous cues in all strands. It is then incorporated into the Auxiliary Trans-sensory Strand in a more user-friendly form, thereby bringing the benefits of augmented-echolocation to the user who is not highly skilled in the traditional echolocation technique.

The invention describes schemes for further extending the trans-sensorial mapping that include commoditization of schemata optimized for a variety of contexts, such as outdoor sport activities, street navigation, household environment, etc.

The invention describes the way the device rendering is to be benchmarked via subjecting test subjects (both visually impaired and normal people) to a controlled video game or VR-environment. Comparative analytics on their performance/survival metrics also provide useful feedback for refining the logics.

Similar method also applies for the training and certifying prospective users before they operate the device in real life. For children, in particular, the invention is highly amenable to gamification, which means significant potential for the wide adoption of the invented system.

A mobile device receiving input of vehicle-generated motion: A Method to turn moving vehicle-generated ambient motional changes into part of game narrative played on mobile devices with adequate sensors, An algorithmic method for real-time capturing and processing of motional ambient data for enhancing the recreation experience of games performed on a phone or other hand-held device for the game player(s) riding on a transportation vehicle

In specially designed movie theaters and virtual reality contraptions, addition of motional and tactile feedback further enhance user's experience. In such cases, the real-life motion/vibration is generated mechanically in sync with the synthesized—artificial/virtual—environmental changes. In the entertainment industries, various ways have been devised to administer physical feedback that matches what's on screen to deliver an immersive experience. In movie theaters, special chairs or wearable devices are the common form, but they are not as widely used in theaters as in specialized theme parks. On gaming devices or mobile devices, the vibration of the control module is the most widely employed method for giving physical feedback to the user. The gyro sensor built-in on a hand-held module adds depth by imparting the user's intent (i.e. titling, shaking, etc of the device) in the interactive 3D gaming context such as in the flight simulation or fighting matches) in an intuitive manner. However, the disparity between the sensation of the external perturbations as felt by the user and what's going on inside the ‘virtual’ environment prevents the user (or the player) from the full engagement, if not leading to a severe nausea. In audio, the noise-cancelling headphones ameliorates such a disparity by cancelling out the outside noise. In video, the size of the screen naturally provides some level of isolation from extraneous distraction; in the Virtual Reality (VR) context, the audio-visual isolation may become complete. The cancellation of tactile and motional sensation induced by the dynamic environmental perturbations without an expensive and unwieldy contraption remains relatively unexplored. The invention describes simple methods to mitigate such intrusion of environmental perturbations and further put them in the service of the user's activity that are designed to take advantage of them.

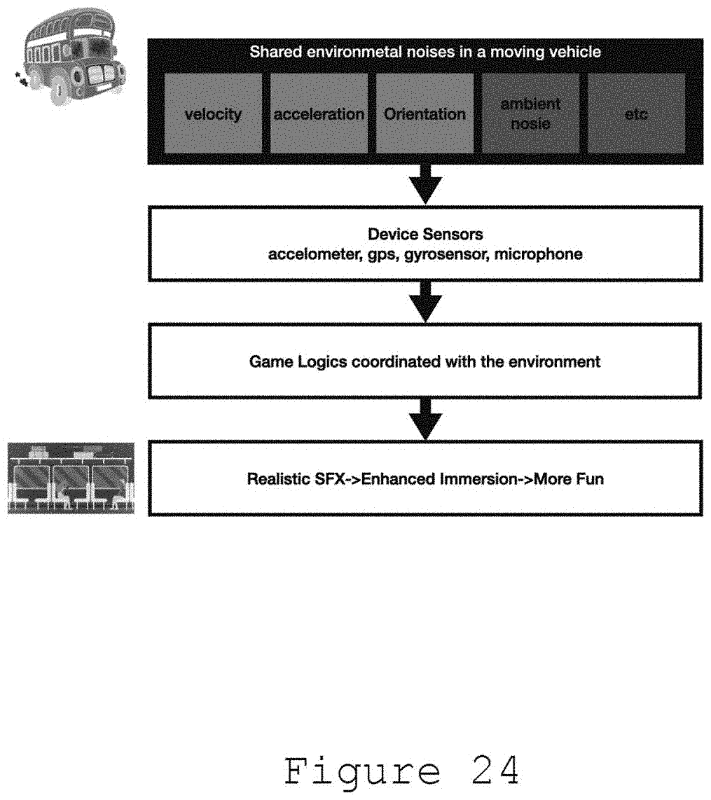

Everyday millions of people commute via subways, buses and carpools. Families travel for hours on automobiles with the passengers often engaged in various recreational activities such as reading, listening to music and playing games on mobile devices. Uneven movements and vibrations that are ubiquitous on transit vehicles are not desirable for such activities in general. Yet, such unwanted environmental nuisances may be turned into advantages for a type of games that have components in game playing context that are deliberately designed to utilize them. An example of how contextualized ‘noise’—the turns and noises from an automobile on the road—becomes an asset derives from the observation of a child having fun from operating the mockup steering-wheel seated behind his parent who is driving. The invention is about actively bringing in such environmental noise to benefit the game player. It describes the way the game algorithm turns the transport-generated motional input to its advantage via adapting various part of its logic to provide useful instant narrative feedback in sync with what's going on physically in the real environment, thereby enhancing the realism and/or level of excitement as the gaming context is designed to use the existing external conditionals as part of its narrative. The invention describes a device, but not exclusive of existing mobile-phones, tablets, or game consoles with appropriately modified system logic and hardware, that has built-in motion sensors and the GPS capability and is capable of imparting the sensor data to its logic for use in real time. The invention also describes the software logic that provides and controls games or simulations on such devices. The invention further describes the specifications that such a device and the logic are required to satisfy in order to provide the functionality as described in it. The invention describes two methods for the users of mobile electronic devices to read or play games. First, it allows the video games played by the general public during transportation to take advantage of the environmentally generated motional cues to deepen their immersive engagement and to add novel narrative controls. Secondly, the same motional cues are put to cancel the unwanted visual perturbation due to the user's physiological condition (hand tremor) or induced by the transport mechanics. The ambient background motion of the transporting vehicle is generally considered a nuisance in the use of mobile devices. The invention describes the practice of gathering the suite of motional metrics and feed them to the on-going game's logic to generate narrative in-game events and effects so that the triggering motion and the induced tactile stimuli—such as the sensation induced on the user's body by the sudden stop or jerk of the car—provides the natural feedback to what is happening on screen. This turns the unavoidable environmental “noise” into a useful feedback mechanic of the game through its dynamic adaptation to the physical environment and its changes. The beneficiary of the invention operates the embodiment of the invention not only to play a game but also to run a role-playing simulation in the professional or education context. For example, the invention is used for assistance in reading or performing a typical-based touch user interface maneuver when the user suffers from the chronic hand tremors. The invention monitors and analyzes the motional metrics of the device and instructs its display mechanism to compensate for the dynamic displacements by instantaneously shifting the reference origin point of the screen graphics in reverse movement. This results in more reliable and robust visual ingestion of what's on screen from the afflicted user's perspective. It is effectively analogous to the background noise canceling headphones for listening to music.

[Definitions of Vehicle, Rigidity, Registry and Perturbation] In what follows, the ‘vehicle’ denotes the container on which the embodying device resides. The important characteristic of the relation between the vehicle and the device is that both share the same set of motional metrics. For example, if the device is held firmly by the user's hand, and if his body parts are in reasonably good ‘registry’ with the movement of an automobile he is in, the ‘vehicle’ containing the device, in the context of this invention, may well be the user's hand, or his body, or the automobile. If the user's body is no longer rigid, that is, if his hand holding the device shakes independently of the overall state of his body, the ‘vehicle’-device relationship ends at his hand. Regarding the quantitative criteria for the ‘rigidity’ and ‘registry’, it is important to note that they depend on the specific usage purpose of each embodiment. When two bodies are in relative motion to each other, the span and timescale of the relative displacement gives the gauge of the severity of perturbation to their perfect registry. Each operational task—be it reading text on a mobile phone or playing with a toy steering wheel for mockup driving—puts different degrees of tolerance for the perturbation that disrupts the perfect registry. When the actual disturbance level is below the tolerance level, the invention considers that the device is in its ‘vehicle’. At any given moment, the motional metrics of the ‘vehicle’ as defined above, include the vehicle's location, speed, orientation, and finer perturbations. The latter, if the ‘vehicle’ is referring to an automobile or a train, are caused by its steering, and by the operation of its parts such as engine and imperfect road (or track) conditions. The ‘perturbation’ in the context of the invention refers to the spatial (usually, lateral) disparity between the device's presentation plane (i.e. screen) and the user's perception entrypoint (eyes). Consider the mobile phone held in the left hand of the user who suffers from hand-tremors caused by advanced age or an ailment (Parkinson's or Multiple Sclerosis). As long as he is firm in his grip, the rigidity criterion is satisfied between the phone and his hand. However, the rest of his body, his head, eyes, and other hand in particular, are not in registry with the ‘phone in its vehicle’. (in most cases, each body part may suffer its own independent tremors.) The intractable displacement of his device beyond what the eyes can follow induces undesirable side effects that strains the eye and cause motion sickness even for unafflicted people. For the seriously afflicted, reading becomes impossible. The concept of background noise-cancelling—fully realized in audio headphones—translates to the cancelling of these tremor induced perturbative displacements (‘registry noises’). [screen-stabilizing mode] A novel and useful aspect of the motional metrics in actual transport vehicles (train, boat, automobiles . . . ) is that parts of their dynamical changes are predictable (or anticipatory). For an apt example, consider someone playing an instance of the so-called platform action video game as a passenger seated inside a moving car. As the player intuitively and subconsciously feels with his own body the gyrations, vibrations and undulations of the car's movement, if the game's logic also ingests and utilizes the same information to make well judged modifications on the behavior of its components (such as the states of its various prop objects and characters) or the logic (difficulty control by virtually tilting or shaking up its playing field, momentarily paralyzing the opponent, just to give a few possible variations). They add elements of surprise, yet pleasantly anticipatory because the user may ‘feel’ it coming through his own tactile/gyroscopic perception of the underlying movement in the physical environment. The judicious timing in injecting the effect of the same perturbatory event into the virtual game mechanics also turns it into a special effect that is effectively felt by the user's whole body. Another interesting aspect of the perturbations in the context of the invention is that the motional metrics are shared by the group of people in shared space, but with varying degrees per granularity. For example, the coarse grained (i.e. low-frequency motional components) component of the motion such as the average movement metrics of the train as the whole is shared by all, but the rigidity of each passenger may vary, as well as among the carriages vary, causing fine-grained and fast-varying perturbations that are felt differently (and at different times, e.g. if the train is turning a corner) among groups of passengers. Such shared motional metrics, perturbative or not, can be put to advantage in a type of multi-party games designed to use such semi-shared environmental cues extensively as part of its logic. For example, consider the people onboard a commute train who are using their mobile phones to play the multi-party video game connected via wireless network connection. Each device ingests the motional metrics of the shared transportational environment but also with deviation arising from each individual's finer grained circumstantial variations. Part of the variations affecting each device is anticipatory not only by its holder, but also by the other players to a degree as they can perceive the physical cues as allowed by the overlaps in their perceptive reach. As a result, such dynamical and external environmental cues, when fed into the game logic as control parameters, become a rich source to generate controlled, yet surprising elements to the gameplay. The GPS, widely available on mobile devices, allows continuous tracking of the device location with accuracy within a few feet. The accelerometer found in most mobile devices captures the smaller scale motion such as the device shakes, change in its velocity, as well as providing the compass function. The gyro-sensor detects the changes made in the device's orientations in the three dimensional space. Furthermore, other useful mechanical fluctuations, vibrations and jerks, etc are detectable through their simple time-series analyses. In as much as we define the ‘vehicle’ to be in registry with the ‘device’, these measurements therefore yield a continual assessment of the vehicle's motional and geographical metric. From GPS, The motional velocity vector (V) and the acceleration vector (A) of the ‘vehicle’ (and the device) are obtained, time-averaged over a brief temporal window of a prescribed duration to reduce random noise. This information is more pertinent to the larger- and relatively steadier component of the motion. The small-scale and fast component of the movement is obtained from readings of the accelerometer and gyro-sensor. The absolute position of the user in the environment is immaterial for the invention's scope. Combined analysis of the on-device compass & gyro-metrics and the GPS derived moving direction, the alignment between the user (i.e. device) orientation and the motional vector is also inferred. If the ‘vehicle’ is a mass-transportation vehicle such as a train or a bus, this also leads to inferring whether the user is seated facing forward or backward, or sideways with respect to the motion at any given moment. The ‘perturbative motion’ defined as the changes in the relative disparity between the focus point of the user's eyes and the prescribed reference point of the device screen can be tracked if the device is equipped with the eye-tracking capability from the logical manipulations of the data from the same. The invention incorporates the set of dynamic motional metrics in the logic to guide its internal processing of the narrative mechanics (if it is for a game) or for the noise-cancelling purposes which purports to eliminate the perturbative part of the motion to assist the user with robust engagement with the device content. (e.g. the user afflicted with hand tremor reading text on a hand-held electronic reading device) For game playing in the transport environment, the motion data set may be used in one of the following ways or their flexible combination as part of the device logic. In this usage context, the ‘perturbative motion’ is assumed to be negligible. A) It may be used to control the state of the game's background platform/landscape. B) It may be selectively or uniformly applied to impact the characters' motion. C) It may impact the behavior of an artifact in the game, such as its trajectory in flight with implied impact on accuracy of a certain weapon etc. Whenever the motion starts or stops, numerous in-game effects can be implemented in sync with what the player physically experiences. Some are used for anticipatory events, others for post event special effects. For example, an abrupt stop may knock off adversarial actors or objects in a scene, putting the gamer at an advantage if he manages to anticipate it through his own physical perception of the environmental hints, and vice versa. Using the forward/backward facing information that are automatically derived by the device logic, the invention allows extra variation depending on whether each game player is facing forward or backward with respect to the vehicle's moving direction. For example, it leads to extra boost or drag on each game player's speed, whether he is running or riding a rocket in the game. FIG. 24 describes the schematic overview of the logic flow that the invention follows in using the environmentally generated motional metrics in the game's narrative and control logic to enhance the player's immersion.

A mobile computing device is adapted to sense motion of a vehicle in which the mobile computing device is positioned, comprising a memory that stores a computer program, a CPU that executes the computer program, a motion sensor module that senses the motion of the mobile computing device, and sends the sensed motion data to the CPU, an input device that receives input by a user of the mobile computing device, an output device that provides output of the computer program in a format that can be sensed by the user. The computer program analyzes the motion data and separates the motion data into user motion data that is induced by the user, and a vehicle motion data that is induced by the vehicle. The vehicle motion data further comprises start of the vehicle, stop of the vehicle, deceleration of the vehicle and the acceleration of the vehicle. The motion sensor module of the invention senses the geographical position of the mobile computing device and also uses an accelerometer, a gyro-sensor and a GPS sensor. For the users suffering excessively shaky hands, the invention may employ the eye-tracking unit in its screen-stabilizing mode. The output of the device metric module includes the user's orientation in the vehicle with respect to the vehicle's moving direction at a given moment. The vehicle motional data (and the users' motion and orientation relative to the vehicular motion) are used as the input for the dynamically adaptive computer program logic. The game comprises one or more backgrounds, one or more characters, one or more artifacts, and a game logic that controls the backgrounds, the characters and the artifacts, wherein the game logic uses the vehicle motion data in control of the backgrounds, the characters or the artifacts. The logic monitors the instantaneous perturbative displacement of the device from its normal position and compensate it by displacing the anchor point of its screen display in the opposite direction by appropriate amount to provide robust reading experience of the screen content for the user afflicted with shaky hand tremors.

1. A device compensating limits of humans senses, comprising:
a) a receiver receiving information in a first sense;
b) a converter converting the received information into information in a second sense; and
c) a presenter that presents the converted information.

2. The device of claim 1, wherein first sense is the vision and the receiver receives visual information comprising texts, wherein the second sense is auditory sense or tactile sensation, wherein the receiver comprises an ingestion layer that ingests information from a target object.

3. The device of claim 2, wherein the ingestion layer is adapted to be held by a finger and has comparable size, wherein the ingestion layer recognizes and extracts the character symbol in its center field of view as content of the visual information changes.

4. The device of claim 2, wherein the ingestion layer is adapted to make direct- or quasi direct contact between a surface of the ingestion layer surface and a print medium.

5. The device of claim 2, wherein the ingestion layer receives the visual information remotely from a print medium.

6. The device of claim 2, wherein the ingestion layer comprises a grid of optical sensors densely populating on the surface of the ingestion layer the size of which is just enough to cover a typical alphabet character in a book.

7. The device of claim 2, wherein the ingestion layer comprises a sensor that exploits the electrical impedance contrast between the inked zone and the pristine paper zone.

8. The device of claim 2, wherein the converter comprises a conversion layer that processes the set of images scanned by the ingestion layer to output a time series of recognized Unicode characters.

9. The device of claim 2, wherein one side of the sensor of the ingestion layer is adapted to be in contact with the user's body such as the tip of the index finger or other (extended) area that is sensitive to a tactile stimulus of a predetermined pattern, wherein the other side of the sensor interfaces with the entity that provides the input data in the form of the streaming train of characters or symbols.

10. The device of claim 2, wherein the presenter comprises a presentation layer that is to generate and present the stream of dynamically and electronically modified patterns that is sensed by the touch-sensitive surface of the user body part in contact with the device.

11. The device of claim 1, wherein the receiver ingests the full audio or visual sensory stimuli, and takes the portion that is blocked for the sensory deprivation of the user, wherein the converter extracts environmental cues contained therein by applying machine intelligence logic and makes trans-sensory conversion to their synthetic representation.

12. The device of claim 11, wherein at any given moment, the raw primary data and the converted cues are consolidated and presented through the user's primary sensory channel.

13. The device of claim 12, wherein scene injection comprises a first category of information recognised by the primary (i.e. fully functioning) sensory organ, and a second category of alternative ingestion devices that substitute for the user's deprived sensor.

14. The device of claim 13, wherein the media data ingested through the categories are analyzed to detect discrete, and noteworthy, environmental cues, and the extracted cues are then converted to their trans-sensorial counterparts so that the user senses them through functioning sensory organs, wherein the converted cues are sub-categorized as AM (Auxiliary Machine-Intelligence cues), AT (Auxiliary Trans-sensorial cues), and T (Tactile cues), wherein AT and AM are delivered through the user's primary sensor and T is through his tactile sensor.

15. The device of claim 14, wherein the cue comprises a vertical thread, which contains dots and vertical lines, wherein the dot symbolically represents a trans-sensorial cue that the device logic identified as a notable environmental cue at a particular time, wherein objects and events last for duration are represented as the vertical lines.

16. The device of claim 15, wherein the Primary Raw (PR) strand stands for the environmental data adapted to be ingested directly through the user's fully functioning sensory channel in raw form, wherein the PR strand may be choked if the user wants to focus exclusively on the cues synthesized by the device (AM, AT).

17. The device of claim 16, wherein the strand can be dynamically controlled to pull the strand to the fore or push it to the background, whereby avoiding sensory overload that leads to more confusion than assistance, wherein the four strands: AT, T, AM, PR can be controlled based on the environment dynamic and the user's intention.

18. The device of claim 17, wherein for aural cues, the volume of the sound or the intensity of synthesized stimuli for tactile cues is the way to control the weight.

19. The device of claim 17, wherein for visual cues, the weight means manipulating attributes of their visual representation, which comprises their alpha values on the screen, color-vibrancy, sizes (for an icon-based rendering), or styles (plain vs. bold faces if the cues are to be rendered as text).

20. The device of claim 17, wherein the device monitors the presence of an obstruction within the volume of a cone in the user's moving direction or around his body, wherein continual availability of these ‘boundary’ or ‘perimeter’ information allows the invention to define the special type of environmental cue, designated as the safety bubble breach cue.
